(19) United States
(12) Patent Application Publication
(10) Pub. No.: US 2016/0142197 A1
(43) Pub. Date: May 19, 2016

(54) Transmission Method and Reception Method for Data and Control Information, Base Station and Terminal

(71) Applicant: ZTE CORPORATION, Guangdong (CN)

(72) Inventors: Senbao GUO, Shenzhen (CN); Bo DAI, Shenzhen (CN); Yunfeng SUN, Shenzhen (CN); Junfeng ZHANG, Shenzhen (CN)

(73) Assignee: ZTE Corporation, Shenzhen City, Guangdong Province (CN)

(21) Appl. No.: 14/897,632

(22) PCT Filed: Apr. 25, 2014
(86) PCT No.: PCT/CN2014/076213

§ 371 Date: Dec. 10, 2015

(30) Foreign Application Priority Data
Jun. 13, 2013 (CN) 201310233847.X

(51) Int. Cl. H04L 5/14; H04B 7/06; H04W 72/04; H04L 5/00

(52) U.S. Cl. CPC H04L 5/1438; H04L 5/0035; H04B 7/0626; H04W 72/0446; H04W 72/042; H04L 5/0007

(57) ABSTRACT

Disclosed in the present invention are a transmission method and a reception method for data and control information, an eNB and a user equipment, wherein the transmission method includes: an eNB transmitting data and/or downlink control information to a user equipment within a service range in TDD special subframes in accordance with specific rules; wherein the specific rules are pre-configured in the eNB or pre-indicated by the eNB to the user equipment via a high-layer signaling; wherein, a serving cell in which the user equipment is located currently performs a coordinated multiple-point (CoMP) transmission with one or more other cells and has an independent TDD special subframe configuration compared with other cells. The eNB includes a memory module and a transmitting module.

### TECHNICAL FIELD

The present document relates to the long term evolution advanced system (called LTE-Advanced), and more particularly, to a transmission method and a reception method for data and control information, an eNB and a user equipment.

### BACKGROUND OF THE RELATED ART

The coordinated multi-point transmission standard technology was introduced in the R11 technical discussions, and the data transmission methods supported by it comprise: JT (Joint Transmission), DPS (Dynamic Point Selection) with/without muting, CS (Coordinated Scheduling) with/without muting, CB (Coordinated Beamforming) and others. The JT mainly refers to that a plurality of nodes can simultaneously transmit data information to one user equipment in allocated subframes, and this transmission method may convert interference signals of strong interference nodes into useful signals, thereby improving the signal to noise ratio of the edge user equipment and the spectral efficiency at the cell edge. The CB makes two user equipments served by the strong interference nodes and serving nodes use the orthogonal spatial characteristic beam to reduce the interference of interference nodes in the spatial beam direction mainly through the beam method. The CS makes the strong-interference nodes not transmitting the data in corresponding time-frequency resources mainly through the joint scheduling, thereby reducing the interference of the strong-interference nodes. The DPS/DPB (Dynamic Point Blanking) can implement the dynamic node switching and can ensure the optimal spectral efficiency at the cell edge at the same time of guaranteeing the load balancing of various nodes.

The prerequisite of the existence of coordinated multiple points is assuming that multiple serving nodes are fully synchronized, thus ensuring the more effective coordinated transmission of the multiple nodes. If data of the multiple nodes are non-aligned, on the one hand, it can result in data reception errors, and on the other hand, it can result in channel estimation errors because the reference channels are not aligned. However, in the TDD (Time Division Duplexing) scenario, particularly in the scenario that the coverage ranges of two nodes are different, even though the two nodes are guaranteed to be fully synchronized, the special frame configurations configured for different nodes are also different due to the different coverage ranges. As shown in FIG. 1, the system has three eNBs, respectively Macro Cell eNB (evolved Node B), Small Cell eNB RRH (Remote Radio Head) 1 as well as RRH2. When these three nodes perform the coordinated transmission, they can use the same subframe configuration, as shown in FIG. 2(a); wherein, D denotes the downlink subframe, U denotes the uplink subframe, and S denotes the special subframe. These three nodes have different coverage ranges, and compared with the RRH1 and the RRH2, the coverage range of the eNB should be larger. When the coverage range required by the eNB is relatively large, typically a relatively large GP (Guard Period) should be configured to ensure the switching time of uplink and downlink subframes, in addition, it also requires that the DwPTS (Downlink Pilot Time Slot) takes up fewer OFDM (Orthogonal Frequency Division Multiplexing) symbols, for example, when using the special sub-frame configuration 0 or 1 in Table 1, and when the coverage range required by the eNB is relatively small, the downlink spectrum utilization rate can be improved by configuring a relatively small GP. A subframe with 1 ms may comprise 14 OFDM symbols when using the normal CP (Cyclic Prefix) configuration, and it may comprise 12 OFMD symbols when using the extended CP configuration, and the special subframe with 1 ms is composed of three parts: DwPTS, GP and UpPTS.

TABLE 1
the length of DwPTS, GP and UpPTS in a special subframe configuration

| | Downlink normal cyclic prefix | | | Downlink extended cyclic prefix | | |
|---|---|---|---|---|---|---|
| Special | | UpPTS | | | UpPTS | |
| subframe | | Uplink normal | Uplink extended | | Uplink normal | Uplink extended |
| configuration | DwPTS | cyclic prefix | cyclic prefix | DwPTS | cyclic prefix | cyclic prefix |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | 12800 · Tₛ | | |
| 8 | 24144 · Tₛ | | | — | — | — |
| 9 | 13168 · Tₛ | | | — | — | — |

Where, Ts indicates the sampling interval.

Furthermore, the unit conversion based on OFDM symbol in Table 1 is shown in Table 2.

TABLE 2
the length of DwPTS, GP and UpPTS in a special subframe configuration

| | Downlink normal cyclic prefix | | | | Downlink extended cyclic prefix | | | |
|---|---|---|---|---|---|---|---|---|
| Special | | UpPTS | | | | UpPTS | | |
| subframe | | Uplink normal | Uplink extended | | | Uplink normal | Uplink extended | |
| configuration | DwPTS | cyclic prefix | cyclic prefix | GP | DwPTS | cyclic prefix | cyclic prefix | GP |
| 0 | 3 | 1 | 1 | About 10 | 3 | 1 | 1 | About 7 |
| 1 | 9 | | | About 4 | 8 | | | About 3 |
| 2 | 10 | | | About 3 | 9 | | | About 2 |
| 3 | 11 | | | About 2 | 10 | | | About 1 |
| 4 | 12 | | | About 1 | 3 | 2 | 2 | About 6 |
| 5 | 3 | 2 | 2 | About 9 | 8 | | | About 2 |
| 6 | 9 | | | About 3 | 9 | | | About 1 |
| 7 | 10 | | | About 2 | 5 | | | About 5 |
| 8 | 11 | | | About 1 | — | — | — | |
| 9 | 6 | | | About 6 | — | — | — | |

At the same time of guaranteeing that the Macro Cell and Small Cell are TDD synchronized, if the same TDD subframe configuration is used, the special subframe configurations used may be different because of their different coverage ranges, as shown in FIG. 2 (b).

For example, when the Macro Cell uses the special subframe configuration 0 in order to obtain a broader coverage range, the Small Cell uses the special subframe configuration 4, and the PDSCH (Physical Downlink Shared Channel) transmissions of the two cells may reach a difference of 9 OFDM symbols. If the user equipment only accesses the Macro Cell, it is considered that the scheduling subframe is the special subframe configuration 0, thus abandoning the PDSCH demodulation and reducing the resource utilization rate.

Due to the different number of OFDM symbols occupied by the DwPTS, the DMRS (De Modulation Reference Signal) corresponding to different special subframe configuration is also different in order to ensure the optimal system performance, as shown in FIG. 3 and FIG. 4, the corresponding DMRSs are different when using the special subframe configuration 1 and the special subframe configuration 4. Assuming that the Macro Cell uses the Special subframe configuration 1 in order to obtain a broader coverage range, the Small Cell uses the Special subframe configuration 4, and the PDSCH transmissions of the two cells can reach an interval of three OFDM symbols. If the user equipment only accesses the Macro Cell, it is considered that the scheduling subframe is the special subframe configuration 1, which will result in that the user equipment selects the wrong demodulation DMRS, and further result in errors in demodulation channel parameters, as well as errors in data rate matching resource elements, and ultimately result in errors in data reception.

As another example, when the Macro Cell uses the Special subframe configuration 1 in order to obtain a broader coverage range, the Small Cell uses the Special subframe configuration 2, and the PDSCH transmissions of the two cells can reach an interval of one OFDM symbol, and if the user equipment only accesses the Macro Cell, it is considered that the scheduling subframe is the Special subframe configuration 1, and the user equipment only receives the first nine OFDM symbols, thus increasing the BLER (Block Error Ratio) of the data reception of user equipment and increasing the probability of data reception error.

### SUMMARY OF THE INVENTION

The purpose of the present document is to provide a transmission method and a reception method for data and control information, an eNB and a user equipment, to overcome the problem that there are errors in the reception of the data and reference signal because subframe termination symbols are not aligned during the multi-point transmission under the existing scenario that special subframe configurations of multiple nodes in the coordinated transmission are different.

To solve the abovementioned problem, the present document provides a method for transmitting data and control information, comprising:

an eNB transmitting data and/or downlink control information to a user equipment within a service range in time division duplexing (TDD) special subframes in accordance with specific rules; wherein the specific rules are preconfigured in the eNB or indicated by the eNB in advance to the user equipment via a high-layer signaling;

wherein, a serving cell in which the user equipment is located currently performs a coordinated multi-point (CoMP) transmission with one or more other cells and has an independent TDD special subframe configuration compared with the other cells.

Preferably, the method further comprises: the eNB pre-configuring at least one set of non-zero power channel state information reference signal (NZP CSI-RS) configuration for the user equipment via the high-layer signaling, wherein each set of NZP CSI-RS configuration corresponds to one set of TDD special subframe configuration signaling; wherein the TDD special subframe configuration signaling comprises a combination of any one or more of the following items:

TDD special subframe configuration index;

TDD uplink and downlink subframe configuration index;

subframe offset information or slot offset information;

an ending position of orthogonal frequency division multiplexing (OFDM) symbols occupied by the data and/or the downlink control information;

the eNB transmitting data to a user equipment within the service range in the TDD special subframes in accordance with the specific rules.

Preferably, the method further comprises:

the eNB pre-configuring at least one channel state information (CSI) process for the user equipment through the high-layer signaling, wherein each CSI process corresponds to one set of TDD special subframe configuration signaling; wherein the TDD special subframe configuration signaling comprises a combination of any one or more of the following items:

TDD special subframe configuration index;

TDD uplink and downlink subframe configuration index;

subframe offset information or slot offset information;

the ending position of orthogonal frequency division multiplexing (OFDM) symbols occupied by the data and/or the downlink control information;

the eNB transmitting data to a user equipment within the service range in the TDD special subframes in accordance with the specific rules.

Preferably, the eNB transmitting data to the user equipment within the service range in the TDD special subframes in accordance with the specific rules comprises:

the eNB only transmitting data in a cell corresponding to a first NZP CSI-RS; or,

the eNB only transmitting data in the serving cell in which the user equipment is located or transmitting data to the user equipment according to a TDD special subframe configuration of the serving cell; or,

the eNB only transmitting data in a cell corresponding to a first CSI process.

Preferably, the method further comprises:

the eNB pre-configuring at least one enhanced physical downlink control channel (EPDCCH) cluster for the user equipment through the high-layer signaling, and respectively configuring one set of TDD special subframe configuration signaling for each EPDCCH cluster; wherein the TDD special subframe configuration signaling comprises a combination of any one or more of the following items:

TDD special subframe configuration index;

TDD uplink and downlink subframe configuration index;

subframe offset information or slot offset information;

the ending position of orthogonal frequency division multiplexing (OFDM) symbols occupied by the data and/or the downlink control information;

the eNB transmitting downlink control information to a user equipment within the service range in the TDD special subframes in accordance with the specific rules comprises:

the eNB transmitting the downlink control information to the user equipment in the service range in the TDD special subframe in accordance with a special subframe configuration signaling configured for a first EPDCCH cluster; or,

for each EPDCCH cluster, the eNB respectively transmitting the downlink control information in the EPDCCH cluster according to the TDD special subframe configuration signaling configured for the EPDCCH cluster; or,

the eNB transmitting the downlink control information in the TDD special subframes according to the TDD special subframe configuration signaling configured for the EPDCCH cluster of the serving cell in which the user equipment is located.

Preferably, the eNB transmitting the downlink control information to a user equipment in the service range in the TDD special subframes in accordance with the specific rules comprises:

the eNB only transmitting the downlink control information in the cell corresponding to the first EPDCCH cluster; alternatively, the eNB transmitting the downlink control information in the EPDCCH cluster corresponding to the serving cell in which the user equipment is located.

Preferably, the method further comprises:

the eNB pre-configuring N special subframe configuration signalings for the user equipment through the high-layer signaling and indicating to the user equipment one of N special subframe configuration signalings corresponding to subframes which currently transmit data through the value of at least part of information bits in the transmitted downlink control information (DCI); wherein N is a positive integer;

the eNB transmitting data to the user equipment within the service range in the special TDD subframes in accordance with the specific rules comprises: the eNB transmitting a physical downlink shared channel (PDSCH) to the user equipment according to a TDD special subframe configuration signaling indicated by the value of information bits in the downlink control information.

Preferably, the eNB transmitting data and/or downlink control information to the user equipment in the service range in the TDD special subframes in accordance with the specific rules comprises: when the eNB determines that the user equipment is configured as a specific transmission mode, a DCI format or a specific mode for receiving downlink control information, the eNB transmitting data and/or downlink control information to the user equipment in the TDD special subframes in accordance with the specific rules, wherein the specific mode for receiving downlink control information is an EPDCCH transmission or a PDCCH transmission.

Preferably, if the eNB determines that the user equipment is configured as transmission mode 10 and the eNB uses demodulation reference signals (DMRS) to transmit a PDSCH to the user equipment in the TDD special subframes, the eNB only transmits the PDSCH in the serving cell in which the user equipment is located.

Preferably, if the eNB determines that the user equipment is configured as the transmission mode 10 and the eNB uses the DMRS to transmit the PDSCH in the TDD special subframes to the user equipment, and when the DCI Format corresponding to the PDSCH is DCI format 1A, the eNB only transmits the PDSCH in the serving cell in which the user equipment is located.

Preferably, if the eNB determines that the user equipment is configured as the transmission mode 10 and the eNB uses the DMRS to transmit the PDSCH to the user equipment in the TDD special subframes, and when the DCI Format corresponding to the PDSCH is the DCI format 1A, the eNB only transmits the PDSCH in the cell corresponding to the first NZP CSI-RS.

Preferably, if the eNB determines that the user equipment is configured as the transmission mode 10 and the eNB uses the DMRS to transmit the PDSCH to the user equipment in the TDD special subframes, and when the DCI Format corresponding to the PDSCH is the DCI format 1A, the eNB only transmits the PDSCH in the cell corresponding to the first CSI process.

Preferably, if the eNB determines that the user equipment is configured as the transmission mode 10 and the eNB uses an EPDCCH to transmit downlink control information to the user equipment in the TDD special subframes, the eNB only transmits the EPDCCH in the serving cell in which the user equipment is located.

Preferably, if the eNB determines that the user equipment is configured as the transmission mode 10 and the eNB uses an EPDCCH to transmit downlink control information to the user equipment in the TDD special subframes, the eNB only transmits the EPDCCH in the cell corresponding to the first EPDCCH cluster.

Preferably, the method comprises: the eNB pre-indicating to the user equipment a NZP CSI-RS configuration or a CSI process configuration associated with data transmitted by the present eNB to the user equipment through at least part of information bits in the transmitted DCI, and instructing the user equipment to use a TDD special subframe configuration signaling corresponding to the NZP CSI-RS configuration or CSI process configuration to receive data.

Preferably, the at least part of the information bits in the DCI are physical downlink shared channel resource element mapping and Quasi-Co-Location indicator (PQI) bits.

Preferably, when multiple nodes configured for one user equipment to perform the multi-point transmission have different TDD special subframe configurations, the eNB predefines that only the serving cell transmits data to the user equipment in corresponding TDD special subframes.

Preferably, when multiple nodes configured for one user equipment to perform a multi-point transmission have different TDD special subframe configurations, and when the difference between the numbers of OFDM symbols in DwPTS areas of two TDD special subframe configurations is greater than N, the eNB predefines that only the serving cell transmits data to the user equipment in the corresponding TDD special subframes, wherein N is a positive integer.

Accordingly, a method for receiving data and control information comprises: a user equipment receiving data and/or downlink control information sent by an eNB in time division duplexing (TDD) special subframes according to specific rules; wherein the specific rules are preconfigured in the user equipment or pre-obtained by receiving a high-layer signaling sent by the eNB;

wherein the serving cell in which the user equipment is located is currently performing a coordinated multi-point transmission with at least one other cell and has an independent TDD special subframe configuration compared with the other cells.

Preferably, the method further comprises: the user equipment pre-receiving at least one set of non-zero power channel state information reference signal (NZP CSI-RS) configurations configured by the eNB for the present user equipment via the high-layer signaling as well as a respective TDD special subframe configuration signaling corresponding to each set of NZP CSI-RS; wherein the TDD special subframe configuration signaling comprises a combination of any one or more of the following items:

TDD special subframe configuration index;

TDD uplink and downlink subframe configuration index;

subframe offset information or slot offset information;

the ending position of orthogonal frequency division multiplexing (OFDM) symbols occupied by the data and/or the downlink control information;

the user equipment receiving data sent by the eNB in the TDD special subframes according to the specific rules.

Preferably, the method further comprises:

the user equipment pre-receiving at least one channel state information (CSI) process configured by the eNB for the present user equipment via the high-layer signaling as well as a respective TDD special subframe configuration signaling corresponding to each CSI process; wherein the TDD special subframe configuration signaling comprises a combination of any one or more of the following items:

TDD special subframe configuration index;

TDD uplink and downlink subframe configuration index;

subframe offset information or slot offset information;

the ending position of orthogonal frequency division multiplexing (OFDM) symbols occupied by the data and/or the downlink control information;

the user equipment receiving data sent by the eNB in the TDD special subframes according to the specific rules.

Preferably, the user equipment receiving data sent by the eNB in the TDD special subframes according to the specific rules comprises:

the user equipment receiving the data in a serving cell in which the user equipment is located; or,

the user equipment receiving the data according to a TDD special subframe configuration signaling of the serving cell in which the present user equipment is located; or,

the user equipment receiving the data in the cell corresponding to the first NZP CSI-RS; or,

the user equipment only receiving the data in the cell corresponding to the first CSI process.

Preferably, the method further comprises: the user equipment pre-receiving at least one enhanced physical downlink control channel (EPDCCH) cluster configured by the eNB for the present user equipment via the high-layer signaling as well as a respective set of TDD special subframe configuration signaling configured for each EPDCCH cluster; wherein the TDD special subframe configuration signaling comprises a combination of any one or more of the following items:

TDD special subframe configuration index;

TDD uplink and downlink subframe configuration index;

subframe offset information or slot offset information;

the ending position of orthogonal frequency division multiplexing (OFDM) symbols occupied by the data and/or the downlink control information;

the downlink control information received by the user equipment from the eNB in the TDD special subframes according to the specific rules comprises: the user equipment receiving the downlink control information according to a TDD special subframe configuration signaling corresponding to the current EPDCCH cluster.

Preferably, the user equipment receiving downlink control information sent by the eNB in the TDD special subframes according to the specific rules comprises: the user equipment receiving downlink control information in the EPDCCH cluster in accordance with the TDD special subframe configuration signaling corresponding to the serving cell in which the present user equipment is located.

Preferably, the method further comprises: the user equipment pre-receiving N special subframe configuration signalings configured by the eNB for the user equipment via the high-layer signaling as well as the downlink control information (DCI); wherein the value of at least part of the information bits in the DCI is used for indicating one of the N special subframe configuration signalings corresponding to the subframes in which the eNB currently transmits data; wherein N is a positive integer;

the user equipment receiving the downlink data information sent by the eNB in the TDD special subframes in accordance with the specific rules comprises: the user equipment receiving the data according to the TDD special subframe configuration signaling indicated by the value of the information bits in the received DCI.

Preferably, the user equipment receiving data and/or downlink control information sent by the eNB in the TDD special subframes in accordance with the specific rules comprises: when the user equipment is configured as a specific transmission mode, a DCI format or a specific mode for receiving downlink control information, the user equipment receiving data and/or downlink control information sent by the eNB in the TDD special subframes according to the specific rules.

Preferably, when the user equipment is configured as transmission mode 10 and the user equipment uses a demodulation reference signal (DMRS) for receiving the PDSCH in the TDD special subframes, the user equipment uses the special subframe configuration of the serving cell in which the present user equipment is located to receive the PDSCH.

Preferably, if the user equipment is configured as the transmission mode 10 and uses the DMRS to receive the PDSCH in the TDD special subframes, and when the DCI Format corresponding to the PDSCH is the DCI format 1A, the user equipment uses the special subframe configuration of the serving cell in which the present user equipment is located to receive the PDSCH.

Preferably, if the user equipment is configured as the transmission mode 10 and the user equipment uses the DMRS to receive the PDSCH in the TDD special subframes, and when the DCI Format corresponding to the PDSCH is the DCI format 1A, the user equipment uses the special subframe configuration signaling of the cell corresponding to the first CSI process to receive the PDSCH.

Preferably, if the user equipment is configured as the transmission mode 10 and uses the DMRS to receive the PDSCH in the TDD special subframes, and when the DCI format corresponding to the PDSCH is the DCI format 1A, the user equipment uses the special subframe configuration signaling of the cell corresponding to the first CSI process to receive the PDSCH.

Preferably, if the user equipment is configured as the transmission mode 10 and uses an EPDCCH to receive the downlink control information in the TDD special subframes, the user equipment uses the special subframe configuration of the serving cell where the user equipment is located to receive the EPDCCH.

Preferably, when the user equipment is configured as the transmission mode 10 and uses the EPDCCH to receive the downlink control information in the TDD special subframes, the user equipment uses the special subframe configuration corresponding to the first EPDCCH cluster to receive the EPDCCH.

Preferably, the method comprises: the user equipment pre-receiving the DCI sent by the eNB to the present user equipment; wherein at least part of information in the DCI is used for indicating the NZP CSI-RS configuration or CSI process configuration used by the data transmitted by the eNB to the present user equipment; the user equipment obtaining the TDD special subframe configuration used for receiving data in the current subframes through the TDD special subframe configuration signaling corresponding to the NZP CSI-RS configuration or CSI process configuration.

Preferably, the at least part of the information bits in the DCI are physical downlink shared channel resource element mapping and Quasi-Co-Location indicator (PQI) bits.

Preferably, when multiple nodes configured for one user equipment to perform a multi-point transmission have different TDD special subframe configurations, the eNB predefines that only the serving cell transmits data to the user equipment in the corresponding TDD special subframes.

Preferably, when multiple nodes configured for one user equipment to perform the multi-point transmission have different TDD special subframe configurations, and when the difference between the numbers of OFDM symbols in the DwPTS areas of the two TDD special subframe configurations is greater than N (N>0), the eNB predefines that only the serving cell transmits data to the user equipment in the corresponding TDD special subframes.

Furthermore, the present document also provides an eNB, comprising:

a memory module, configured to: save specific rules; wherein the specific rules are pre-configured in the memory module or indicated by a transmitting module in advance to the user equipment via a high-layer signaling;

the transmitting module, configured to: transmit data and/or downlink control information to a user equipment within the service range in time division duplexing (TDD) special subframes in accordance with the specific rules saved in the memory module;

wherein the serving cell in which the user equipment is located currently performs a coordinated multi-point transmission with at least one other cell and has an independent TDD special subframe configuration compared with the other cells.

Preferably, the memory module is further configured to: save at least one set of non-zero power channel state information reference signal (NZP CSI-RS) configuration pre-configured for the user equipment via the high-layer signaling, wherein each set of NZP CSI-RS configuration corresponds to one set of TDD special subframe configuration signaling; wherein the TDD special subframe configuration signaling comprises a combination of any one or more of the following items:

TDD special subframe configuration index;

TDD uplink and downlink subframe configuration index;

subframe offset information or slot offset information;

the ending position of orthogonal frequency division multiplexing (OFDM) symbols occupied by the data and/or the downlink control information;

the transmitting module is configured to: transmit data to a user equipment within the service range in the TDD special subframes in accordance with the specific rules.

Preferably, the memory module is further configured to: save at least one channel state information (CSI) process pre-configured for the user equipment via the high-layer signaling, wherein each CSI process corresponds to one set of TDD special subframe configuration signaling; wherein the TDD special subframe configuration signaling comprises a combination of any one or more of the following items:

TDD special subframe configuration index;

TDD uplink and downlink subframe configuration index;

subframe offset information or slot offset information;

the ending position of orthogonal frequency division multiplexing (OFDM) symbols occupied by the data and/or the downlink control information;

the transmitting module is configured to: transmit data to a user equipment within the service range in the TDD special subframes in accordance with the specific rules.

Preferably, the transmitting module is configured to: transmit data to the user equipment within the service range in the TDD special subframes in accordance with the specific rules saved in the memory module, comprising:

the transmitting module only transmitting data in a cell corresponding to the first NZP CSI-RS; or,

the transmitting module only transmitting data in the serving cell in which the user equipment is located or transmitting data to the user equipment in accordance with the TDD special subframe configuration of the serving cell; or,

the transmitting module only transmitting data in the cell corresponding to the first CSI process.

Preferably, the memory module is further configured to: save at least one enhanced physical downlink control channel (EPDCCH) cluster pre-configured for the user equipment via the high-layer signaling, as well as one set of TDD special subframe configuration signaling configured for each EPDCCH cluster; wherein the TDD special subframe configuration signaling comprises a combination of any one or more of the following items:

TDD special subframe configuration index;

TDD uplink and downlink subframe configuration index;

subframe offset information or slot offset information;

the ending position of orthogonal frequency division multiplexing (OFDM) symbols occupied by the data and/or the downlink control information;

the transmitting module is configured to: in accordance with the specific rules, transmit downlink control information to the user equipment within the service range in the TDD special subframes, comprising:

the transmitting module transmits the downlink control information to the user equipment within the service range according to special subframe configuration signalings configured for the first EPDCCH cluster; or,

for each EPDCCH cluster, the transmitting module respectively transmitting the downlink control information in the EPDCCH cluster according to the TDD special subframe configuration signalings configured for the EPDCCH cluster; or,

the transmitting module transmitting the downlink control information according to the TDD special subframe configuration signalings configured for the EPDCCH cluster of the serving cell in which the user equipment is located.

Preferably, the transmitting module is configured to: transmit the downlink control information to the user equipment within the service range in the TDD special subframes in accordance with the specific rules, comprising

the transmitting module only transmitting the downlink control information in the cell corresponding to the first EPDCCH cluster; or, the transmitting module transmitting the downlink control information in the EPDCCH cluster corresponding to the serving cell in which the user equipment is located.

Preferably, the memory module is further configured to: save N special subframe configuration signalings pre-configured for the user equipment through the high-layer signaling;

the transmitting module is further configured to: indicate to the user equipment one of the N special subframe configuration signalings corresponding to the subframes which currently transmit the data via the value of at least part of information bits in the transmitted downlink control information (DCI); wherein N is a positive integer;

the transmitting module is configured to: transmit data to the user equipment within the service range in the TDD special subframes in accordance with the specific rules, comprising: the transmitting module transmitting a physical downlink shared channel (PDSCH) to the user equipment according to the TDD special subframe configuration signalings indicated by the value of the information bits in the downlink control information.

Preferably, the transmitting module is configured to: transmit data and/or downlink control information to the user equipment in the service range in the TDD special subframes in accordance with the specific rules, comprising: if the transmitting module determines that the user equipment is configured as a specific transmission mode, a DCI format or a specific mode for receiving downlink control information, the transmitting module transmitting data and/or downlink control information to the user equipment in the TDD special subframes in accordance with the specific rules, wherein the specific mode for receiving downlink control information is an EPDCCH transmission or a PDCCH transmission.

Preferably, the transmitting module is configured to: when determining that the user equipment is configured as transmission mode 10 and the present eNB uses a demodulation reference signal (DMRS) to transmit the PDSCH to the user equipment in the TDD special subframes, only transmit the PDSCH in the serving cell in which the user equipment is located.

Preferably, the transmitting module is configured to: if determining that the user equipment is configured as the transmission mode 10 and the present eNB uses the DMRS to transmit the PDSCH to the user equipment in the TDD special subframes, and when the DCI format corresponding to the PDSCH is DCI format 1A, only transmit the PDSCH in the serving cell in which the user equipment is located.

Preferably, the transmitting module is configured to: if determining that the user equipment is configured as the transmission mode 10 and the present eNB uses the DMRS to transmit the PDSCH to the user equipment in the TDD special subframes, and when the DCI format corresponding to the PDSCH is the DCI format 1A, only transmit the PDSCH in the cell corresponding to the first NZP CSI-RS; or, when the user equipment is configured as the transmission mode 10 and the present eNB uses the DMRS to transmit the PDSCH to the user equipment in the TDD special subframes, and when the DCI format corresponding to the PDSCH is the DCI format 1A, only transmit the PDSCH in the cell corresponding to the first NZP CSI-RS;

Preferably, the transmitting module is configured to: if determining that the user equipment is configured as the transmission mode 10 and the present eNB uses the DMRS to transmit the PDSCH to the user equipment in the TDD special subframes, and when the DCI format corresponding to the PDSCH is the DCI format 1A, only transmit the PDSCH in the cell corresponding to the first CSI process.

Preferably, the transmitting module is configured to: if determining that the user equipment is configured as the transmission mode 10 and the present eNB uses the EPDCCH to transmit downlink control information to the user equipment in the TDD special subframes, only transmit the EPDCCH in the serving cell in which the user equipment is located.

Preferably, the transmitting module is configured to: if determining that the user equipment is configured as the transmission mode 10 and the present eNB uses the EPDCCH to transmit downlink control information to the user equipment in the TDD special subframes, only transmit the EPDCCH in the cell corresponding to the first EPDCCH cluster.

Preferably, the transmitting module pre-indicates to the user equipment a NZP CSI-RS configuration or CSI process configuration associated with data transmitted by the present eNB to the user equipment through at least part of information bits in the transmitted DCI, thus indicating the user equipment to use the TDD special subframe configuration corresponding to the NZP CSI-RS configuration or the CSI process configuration to receive data.

Preferably, the at least part of the information bits in the DCI are physical downlink shared channel resource element mapping and Quasi-Co-Location indicator (PQI) bits.

Preferably, when multiple nodes configured for one user equipment to perform a multi-point transmission have different TDD special subframe configurations, the eNB predefines that only the serving cell transmits data to the user equipment in the corresponding TDD special subframes.

Preferably, when multiple nodes configured for one user equipment to perform a multi-point transmission have different TDD special subframe configurations, and when the difference between the numbers of OFDM symbols in DwPTS areas of two TDD special subframe configurations is greater than N, the eNB pre-defines that only the serving cell transmits data to the user equipment in the corresponding TDD special subframes.

The present document further comprises a user equipment, comprising:

a memory module, configured to: save specific rules; wherein the specific rules are pre-configured in the memory module or pre-obtained by receiving a high-layer signaling sent from an eNB via a receiving module;

a receiving module, configured to: receive data and/or downlink control information sent by the eNB in time division duplexing (TDD) special subframes according to the specific rules saved in the memory module;

wherein the serving cell in which the user equipment is located is currently performing a coordinated multipoint transmission with at least one other cell and has an independent TDD special subframe configuration compared with the other cells.

Preferably, the receiving module is further configured to: pre-receive at least one set of non-zero power channel state information reference signal (NZP CSI-RS) configuration configured by the eNB for the present user equipment via the high-layer signaling, as well as a respective TDD special subframe configuration signaling corresponding to each set of NZP CSI-RS, and save them into the memory module;

the receiving module is configured to: receive data sent by the eNB in the TDD special subframes according to the specific rules; wherein the TDD special subframe configuration signaling comprises a combination of any one or more of the following items:

TDD special subframe configuration index;

TDD uplink and downlink subframe configuration index;

subframe offset information or slot offset information;

the ending position of orthogonal frequency division multiplexing (OFDM) symbols occupied by the data and/or the downlink control information;

Preferably, the receiving module is further configured to: pre-receive at least one channel state information (CSI) process configured by the eNB for the present user equipment via the high-layer signaling as well as a respective TDD special subframe configuration signaling corresponding to each CSI process, and save them into the memory module; wherein the TDD special subframe configuration signaling comprises a combination of any one or more of the following items:

TDD special subframe configuration index;

TDD uplink and downlink subframe configuration index;

subframe offset information or slot offset information;

the ending position of orthogonal frequency division multiplexing (OFDM) symbols occupied by the data and/or the downlink control information;

the receiving module is configured to: receive data sent by the eNB in the TDD special subframes according to the specific rules.

Preferably, the receiving module is configured to: receive data sent by the eNB in the TDD special subframe according to the specific rules, comprising:

the receiving module receiving the data in a serving cell in which the user equipment is located; or,

the receiving module receiving the data according to a TDD special subframe configuration signaling of the serving cell in which the present user equipment is located; or,

the receiving module receiving the data in a cell corresponding to the first NZP CSI-RS; or,

the receiving module only receiving the data in a cell corresponding to the first CSI process.

Preferably, the receiving module is further configured to: pre-receive at least one enhanced physical downlink control channel (EPDCCH) cluster configured by the eNB for the present user equipment via the high-layer signaling as well as one set of TDD special subframe configuration signaling configured for each EPDCCH cluster and save them into the memory module; wherein the TDD special subframe configuration signaling comprises a combination of any one or more of the following items:

TDD special subframe configuration index;

TDD uplink and downlink subframe configuration index;

subframe offset information or slot offset information;

the ending position of orthogonal frequency division multiplexing (OFDM) symbols occupied by the data and/or the downlink control information;

the receiving module is configured to: receive downlink control information sent by the eNB in TDD special subframes according to the specific rules, comprising: the receiving module receiving the downlink control information according to the TDD special subframe configuration signaling corresponding to the current EPDCCH cluster.

Preferably, the receiving module is configured to: receive the downlink control information sent by the eNB in the TDD special subframes according to the specific rules, comprising: the receiving module being used for receiving downlink control information in an EPDCCH cluster in accordance with the TDD special subframe configuration signaling corresponding to the serving cell in which the present user equipment is located.

Preferably, the receiving module is further configured to: pre-receive N special subframe configuration signalings configured by the eNB for the present user equipment via the high-layer signaling as well as the downlink control information (DCI); wherein, the value of at least part of the information bits in the DCI is used for indicating one of the N special subframe configuration signalings corresponding to the subframes in which the eNB currently transmits data; wherein N is a positive integer;

the receiving module is configured to: receive the downlink data information sent by the eNB in the TDD special subframes in accordance with the specific rules, comprising: the receiving module receiving the data according to the TDD special subframe configuration signaling indicated by the value of the information bits in the received DCI.

Preferably, the receiving module is further configured to: receive data and/or downlink control information sent by the eNB in the TDD special subframes in accordance with the specific rules, comprising: when the the present user equipment is configured as a specific transmission mode, a DCI format or a specific mode for receiving downlink control information, the receiving module receiving data and/or downlink control information sent by the eNB in the TDD special subframes according to the specific rules.

Preferably, the receiving module is configured to: if the present user equipment is configured as the transmission mode 10 and the present user equipment uses a demodulation reference signal (DMRS) for receiving the PDSCH in the TDD special subframes, use a special subframe configuration of the serving cell in which the present user equipment is located to receive the PDSCH.

Preferably, the receiving module is configured to: if the present user equipment is configured as the transmission mode 10 and uses the DMRS to receive the PDSCH in the TDD special subframes, and when the DCI format corresponding to the PDSCH is the DCI format 1A, use the special subframe configuration of the serving cell in which the present user equipment is located to receive the PDSCH.

Preferably, the receiving module is configured to: when the user equipment is configured as the transmission mode 10 and the user equipment uses the DMRS to receive the PDSCH in the TDD special subframes, and when the DCI format corresponding to the PDSCH is the DCI format 1A, use the special subframe configuration signaling of the cell corresponding to the first NZP CSI-RS to receive the PDSCH.

Preferably, the receiving module is configured to: when the present user equipment is configured as the transmission mode 10 and the user equipment uses the DMRS to receive the PDSCH in the TDD special subframes, and when the DCI format corresponding to the PDSCH is the DCI format 1A, use the special subframe configuration signaling of the cell corresponding to the first CSI process to receive the PDSCH.

Preferably, the receiving module is configured to: when the user equipment is configured as the transmission mode 10 and the present user equipment uses the EPDCCH to receive the downlink control information in the TDD special subframes, use the special subframe configuration of the serving cell where the user equipment is located to receive the EPDCCH.

Preferably, the receiving module is configured to: when the user equipment is configured as the transmission mode 10 and the user equipment uses the EPDCCH to receive the downlink control information in the TDD special subframes, use the special subframe configuration corresponding to the first EPDCCH cluster to receive the EPDCCH.

Preferably, the user equipment comprises: the receiving module pre-receiving the DCI sent by the eNB to the present user equipment; wherein, at least part of the information in the DCI is used for indicating the NZP CSI-RS configuration or CSI process configuration used by the data transmitted by the eNB to the present user equipment; the receiving module is further used for obtaining the TDD special subframe configuration used for receiving data in the current subframes via the TDD special subframe configuration corresponding to the NZP CSI-RS configuration or the CSI process configuration.

Preferably, the at least part of the information bits in the DCI are physical downlink shared channel resource element mapping and Quasi-Co-Location indicator (PQI) bits.

In the embodiments of the present invention, it tries to guarantee that all of the TDD special subframes can be used for coordinated multi-point transmission while solving the problem of reception error during performing the coordinated multi-point transmission in the TDD special subframes, thus reducing the scheduling restrictions on the eNB.

### BRIEF DESCRIPTION OF THE DRAWINGS

FIG. 1 is a schematic diagram of different coverage requirements of Macro and Pico nodes in the related art;

FIGS. 2 (a) and 2 (b) are respectively TDD subframe configurations and special subframe configurations of macro and micro eNBs in the related art;

FIG. 3 is a DMRS pattern when using a special subframe configuration 1 in the related art;

FIG. 4 is a DMRS pattern when using a special subframe configuration 4 in the related art;

FIG. 5 is a structural diagram of an eNB in accordance with an embodiment of the present invention.

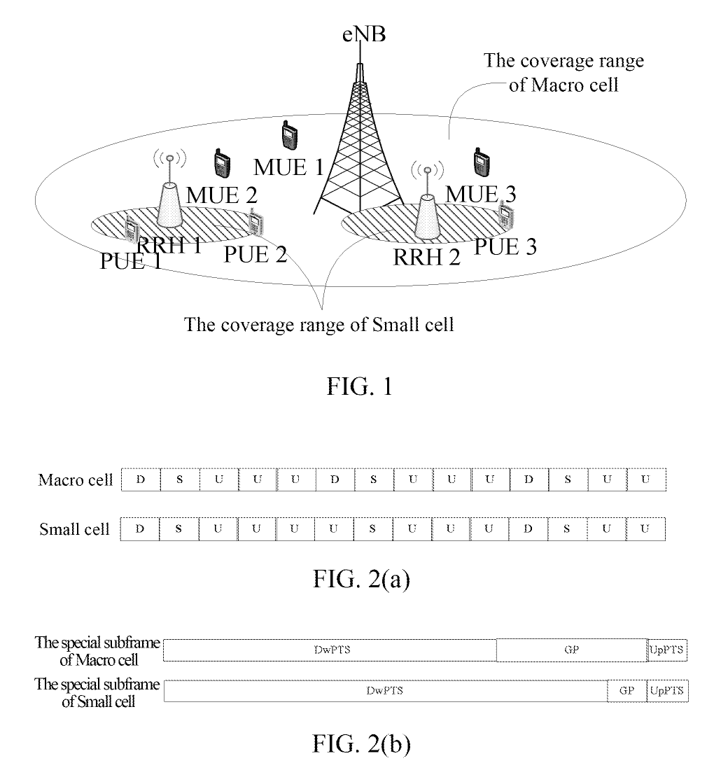

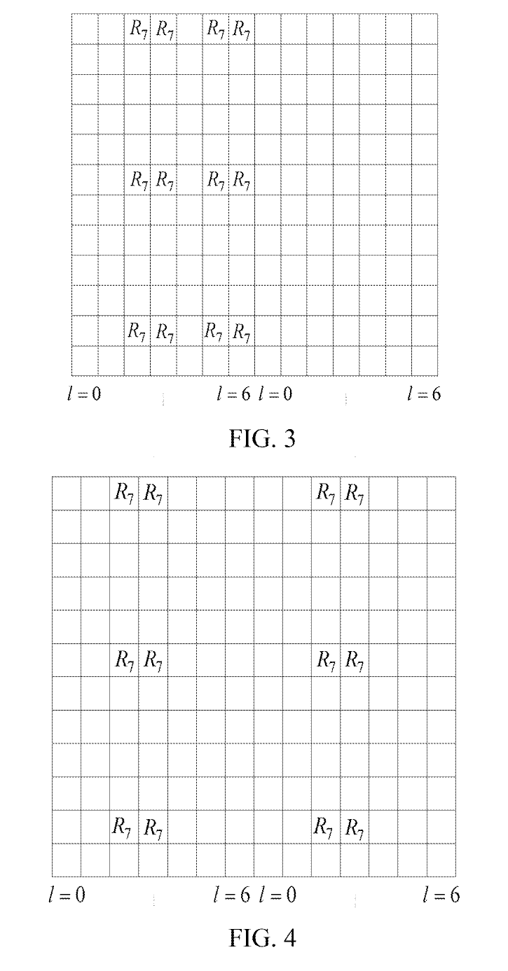

### PREFERRED EMBODIMENTS OF THE INVENTION

Hereinafter, in conjunction with the accompanying figures, the embodiments of the present invention will be described in detail. It should be noted that, in the case of no conflict, embodiments in the present application and features of the embodiments may be arbitrarily combined with each other.

The present embodiment has a method for transmitting data and control information, comprising:

an eNB transmitting data and/or downlink control information to a user equipment within a service range in time division duplexing (TDD) special subframes in accordance with specific rules; wherein the specific rules are preconfigured in the eNB or pre-indicated by the eNB to the user equipment via a high-layer signaling;

wherein, the serving cell in which the user equipment is located currently performs a coordinated multi-point (CoMP) transmission with one or more other cells and has an independent TDD special subframe configuration compared with the other cells.

Preferably, the method further comprises:

the eNB pre-configuring at least one set of non-zero power channel state information reference signal (NZP CSI-RS) configuration for the user equipment via the high-layer signaling, wherein each set of NZP CSI-RS configuration corresponds to one set of TDD special subframe configuration signaling; wherein the TDD special subframe configuration signaling comprises a combination of any one or more of the following items:

TDD special subframe configuration index;

TDD uplink and downlink subframe configuration index;

subframe offset information or slot offset information;

an ending position of orthogonal frequency division multiplexing (OFDM) symbols occupied by the data and/or the downlink control information;

the eNB transmitting data to a user equipment within the service range in the TDD special subframes in accordance with the specific rules, specifically comprising:

the eNB transmitting data to the user equipment according to the TDD special subframe configuration corresponding to the first NZP CSI-RS.

Preferably, the method further comprises:

the eNB pre-configuring at least one channel state information (CSI) process for the user equipment through the high-layer signaling, wherein each CSI process corresponds to one set of TDD special subframe configuration signaling; wherein the TDD special subframe configuration signaling comprises a combination of any one or more of the following items:

TDD special subframe configuration index;

TDD uplink and downlink subframe configuration index;

subframe offset information or slot offset information;

the ending position of orthogonal frequency division multiplexing (OFDM) symbols occupied by the data and/or the downlink control information;

the eNB transmitting data to a user equipment within the service range in the TDD special subframes in accordance with the specific rules, specifically comprising: the eNB transmitting data to the user equipment according to the TDD special subframe configuration corresponding to the first CSI process.

Preferably, the eNB transmitting data to the user equipment within the service range in the TDD special subframes in accordance with the specific rules comprises:

the eNB only transmitting data in a cell corresponding to the first NZP CSI-RS; or,

the eNB only transmitting data in the serving cell in which the user equipment is located or transmitting data to the user equipment according to a TDD special subframe configuration of the serving cell; or,

the eNB only transmitting data in a cell corresponding to the first CSI process.

Preferably, the method further comprises:

the eNB pre-configuring at least one enhanced physical downlink control channel (EPDCCH) cluster for the user equipment through the high-layer signaling, and respectively configuring one set of TDD special subframe configuration signaling for each EPDCCH cluster; wherein the TDD special subframe configuration signaling comprises a combination of any one or more of the following items:

TDD special subframe configuration index;

TDD uplink and downlink subframe configuration index;

subframe offset information or slot offset information;

the ending position of orthogonal frequency division multiplexing (OFDM) symbols occupied by the data and/or the downlink control information;

the eNB transmitting downlink control information to a user equipment within the service range in the TDD special subframes in accordance with the specific rules, specifically comprising:

the eNB transmitting the downlink control information to the user equipment in the service range in the TDD special subframe in accordance with special subframe configuration signalings configured for a first EPDCCH cluster; or,

for each EPDCCH cluster, the eNB respectively transmitting the downlink control information in the EPDCCH cluster according to the TDD special subframe configuration signaling configured for the EPDCCH cluster; or,

the eNB transmitting the downlink control information in the TDD special subframes according to the TDD special subframe configuration signaling configured for the EPDCCH cluster of the serving cell in which the user equipment is located.

Preferably, the eNB transmits the downlink control information to a user equipment in the service range in the TDD special subframes in accordance with the specific rules, specifically comprising:

the eNB only transmitting the downlink control information in the cell corresponding to the first EPDCCH cluster; or,

the eNB transmitting the downlink control information in the EPDCCH cluster corresponding to the serving cell in which the user equipment is located.

Preferably, the method further comprises:

the eNB pre-configuring N special subframe configuration signalings for the user equipment through the high-layer signaling and indicating to the user equipment one of N special subframe configuration signalings corresponding to subframes which currently transmit data through the value of at least part of information bits in the transmitted downlink control information (DCI); wherein N is a positive integer;

the eNB transmitting data to the user equipment within the service range in the special TDD subframes in accordance with the specific rules comprises: the eNB transmitting a physical downlink shared channel (PDSCH) to the user equipment according to a TDD special subframe configuration signaling indicated by the value of information bits in the downlink control information.

Preferably, the eNB transmitting data and/or downlink control information to the user equipment in the service range in the TDD special subframes in accordance with the specific rules comprises: if the eNB determines that the user equipment is configured as a specific transmission mode, a DCI format or a specific mode for receiving downlink control information, the eNB transmitting data and/or downlink control information to the user equipment in the TDD special subframes in accordance with the specific rules, wherein the specific mode for receiving downlink control information is an EPDCCH transmission or a PDCCH transmission.

Preferably, if the eNB determines that the user equipment is configured as transmission mode 10 and the eNB uses demodulation reference signals (DMRS) to transmit PDSCH to the user equipment in the TDD special subframes, the eNB only transmits the PDSCH in the serving cell in which the user equipment is located.

Preferably, if the eNB determines that the user equipment is configured as the transmission mode 10 and the eNB uses the DMRS to transmit the PDSCH to the user equipment in the TDD special subframes, and when the DCI format corresponding to the PDSCH is DCI format 1A, the eNB only transmits the PDSCH in the serving cell in which the user equipment is located.

Preferably, if the eNB determines that the user equipment is configured as the transmission mode 10 and the eNB uses the DMRS to transmit the PDSCH to the user equipment in the TDD special subframes, and when the DCI Format corresponding to the PDSCH is the DCI format 1A, the eNB only transmits the PDSCH in the cell corresponding to the first NZP CSI-RS.

Preferably, if the eNB determines that the user equipment is configured as the transmission mode 10 and the eNB uses the DMRS to transmit the PDSCH to the user equipment in the TDD special subframes, and when the DCI format corresponding to the PDSCH is the DCI format 1A, the eNB only transmits the PDSCH in the cell corresponding to the first CSI process.

Preferably, if the eNB determines that the user equipment is configured as the transmission mode 10 and the eNB uses an EPDCCH to transmit downlink control information to the user equipment in the TDD special subframes, the eNB only transmits the EPDCCH in the serving cell in which the user equipment is located.

Preferably, if the eNB determines that the user equipment is configured as the transmission mode 10 and the eNB uses an EPDCCH to transmit downlink control information to the user equipment in the TDD special subframes, the eNB only transmits the EPDCCH in the cell corresponding to the first EPDCCH cluster.

Preferably, the method specifically comprises:

the eNB pre-indicating to the user equipment a NZP CSI-RS configuration or a CSI process configuration associated with data transmitted by the present eNB to the user equipment through at least part of information bits in the transmitted DCI, and instructing the user equipment to use a TDD special subframe configuration signaling corresponding to the NZP CSI-RS configuration or the CSI process configuration to receive data.

Preferably, the at least part of the information bits in the DCI are physical downlink shared channel resource element mapping and Quasi-Co-Location indicator (PQI) bits.

Preferably, when multiple nodes configured for one user equipment to perform a multi-point transmission have different TDD special subframe configurations, the eNB predefines that only the serving cell transmits data to the user equipment in corresponding TDD special subframes.

Preferably, when multiple nodes configured for one user equipment to perform a multi-point transmission have different TDD special subframe configurations, and when the difference between the numbers of OFDM symbols in DwPTS areas of two TDD special subframe configurations is greater than N, the eNB predefines that only the serving cell transmits data to the user equipment in the corresponding TDD special subframes, wherein N is a positive integer.

Accordingly, a method for receiving data and control information comprises:

a user equipment receiving data and/or downlink control information sent by an eNB in time division duplexing (TDD) special subframes according to specific rules; wherein the specific rules are pre-configured in the user equipment or pre-obtained by receiving a high-layer signaling sent by the eNB;

wherein, the serving cell in which the user equipment is located is currently performing a coordinated multi-point transmission with at least one other cell and has an independent TDD special subframe configuration compared with the other cells.

Preferably, the method further comprises:

the user equipment pre-receiving at least one set of non-zero power channel state information reference signal (NZP CSI-RS) configurations configured by the eNB for the present user equipment via the high-layer signaling, as well as a respective TDD special subframe configuration signaling corresponding to each set of NZP CSI-RS; wherein the TDD special subframe configuration signaling comprises a combination of any one or more of the following items:

TDD special subframe configuration index;

TDD uplink and downlink subframe configuration index;

subframe offset information or slot offset information;

the ending position of orthogonal frequency division multiplexing (OFDM) symbols occupied by the data and/or the downlink control information;

the user equipment receiving data sent by the eNB in the TDD special subframes according to the specific rules.

Preferably, the method further comprises:

the user equipment pre-receiving at least one channel state information (CSI) process configured by the eNB for the present user equipment via the high-layer signaling as well as a respective TDD special subframe configuration signaling corresponding to each CSI process; wherein the TDD special subframe configuration signaling comprises a combination of any one or more of the following items:

TDD special subframe configuration index;

TDD uplink and downlink subframe configuration index;

subframe offset information or slot offset information;

the ending position of orthogonal frequency division multiplexing (OFDM) symbols occupied by the data and/or the downlink control information;

the user equipment receiving data sent by the eNB in the TDD special subframes according to the specific rules, specifically comprising:

the user equipment receiving the data according to the TDD special subframe configuration corresponding to the first CSI process.

Preferably, the user equipment receiving data sent by the eNB in the TDD special subframes according to the specific rules specifically comprises:

the user equipment receiving the data in a serving cell in which the present user equipment is located; or,

the user equipment receiving the data according to a TDD special subframe configuration signaling of the serving cell in which the present user equipment is located; or,

the user equipment receiving the data in the cell corresponding to the first NZP CSI-RS; or,

the user equipment only receiving the data in the cell corresponding to the first CSI process.

Preferably, the method further comprises:

the user equipment pre-receiving at least one enhanced physical downlink control channel (EPDCCH) cluster configured by the eNB for the present user equipment via the high-layer signaling as well as one set of TDD special subframe configuration signaling configured for each EPDCCH cluster; wherein the TDD special subframe configuration signaling comprises a combination of any one or more of the following items:

TDD special subframe configuration index;

TDD uplink and downlink subframe configuration index;

subframe offset information or slot offset information;

the ending position of orthogonal frequency division multiplexing (OFDM) symbols occupied by the data and/or the downlink control information;

the user equipment receiving the downlink control information sent from the eNB in the TDD special subframes according to the specific rules specifically comprises:

the user equipment receiving the downlink control information according to a TDD special subframe configuration signaling corresponding to the current EPDCCH cluster.

Preferably, the user equipment receiving downlink control information sent by the eNB in the TDD special subframes according to the specific rules specifically comprises:

the user equipment receiving downlink control information in the EPDCCH cluster in accordance with the TDD special subframe configuration signaling corresponding to the serving cell in which the present user equipment is located.

Preferably, the method further comprises:

the user equipment pre-receiving N special subframe configuration signalings configured by the eNB for the user equipment via the high-layer signaling as well as the downlink control information (DCI); wherein, the value of at least part of the information bits in the DCI is used for indicating one of the N special subframe configuration signalings corresponding to the subframes in which the eNB currently transmits data; wherein N is a positive integer;

the user equipment receiving the downlink data information sent by the eNB in the TDD special subframes in accordance with the specific rules specifically comprises: the user equipment receiving the data according to the TDD special subframe configuration signaling indicated by the value of the information bits in the received DCI.

Preferably, the user equipment receiving data and/or downlink control information sent by the eNB in the TDD special subframes in accordance with the specific rules specifically comprises: when the user equipment is configured as a specific transmission mode, a DCI format or a specific mode for receiving downlink control information, the user equipment receiving data and/or downlink control information sent by the eNB in the TDD special subframes according to the specific rules.

Preferably, when the user equipment is configured as transmission mode 10 and the user equipment uses a demodulation reference signal (DMRS) for receiving the PDSCH in the TDD special subframes, the user equipment uses the special subframe configuration of the serving cell in which the present user equipment is located to receive the PDSCH.

Preferably, when the user equipment is configured as the transmission mode 10 and uses the DMRS to receive the PDSCH in the TDD special subframes, and when the DCI format corresponding to the PDSCH is the DCI format 1A, the user equipment uses the special subframe configuration of the serving cell in which the present user equipment is located to receive the PDSCH.

Preferably, when the user equipment is configured as the transmission mode 10 and the user equipment uses the DMRS to receive the PDSCH in the TDD special subframes, and when the DCI Format corresponding to the PDSCH is the DCI format 1A, the user equipment uses the special subframe configuration signaling of the cell corresponding to the first CSI process to receive the PDSCH.

Preferably, when the user equipment is configured as the transmission mode 10 and uses the DMRS to receive the PDSCH in the TDD special subframes, and when the DCI format corresponding to the PDSCH is the DCI format 1A, the user equipment uses the special subframe configuration signaling of the cell corresponding to the first CSI process to receive the PDSCH.

Preferably, if the user equipment is configured as the transmission mode 10 and uses an EPDCCH to receive the downlink control information in the TDD special subframes, the user equipment uses the special subframe configuration of the serving cell where the user equipment is located to receive the EPDCCH.

Preferably, when the user equipment is configured as the transmission mode 10 and uses the EPDCCH to receive the downlink control information in the TDD special subframes, the user equipment uses the special subframe configuration corresponding to the first EPDCCH cluster to receive the EPDCCH.

Preferably, the method specifically comprises: the user equipment pre-receiving the DCI sent by the eNB to the present user equipment; wherein, at least part of information in the DCI is used for indicating the NZP CSI-RS configuration or CSI process configuration used by the data transmitted by the eNB to the present user equipment; the user equipment obtaining the TDD special subframe configuration used for receiving data in the current subframe through the TDD special subframe configuration signaling corresponding to the NZP CSI-RS configuration or the CSI process configuration.

Preferably, the at least part of the information bits in the DCI are physical downlink shared channel resource element mapping and Quasi-Co-Location indicator (PQI) bits.

Preferably, when multiple nodes configured for one user equipment to perform a multi-point transmission have different TDD special subframe configurations, the eNB predefines only the serving cell transmits data to the user equipment in the corresponding TDD special subframes.

Preferably, when multiple nodes configured for one user equipment to perform a multi-point transmission have different TDD special subframe configurations, and when the difference between the numbers of OFDM symbols in the DwPTS areas of the two TDD special subframe configurations is greater than N (N>0), the eNB predefines that only the serving cell transmits data to the user equipment in the corresponding TDD special subframes.

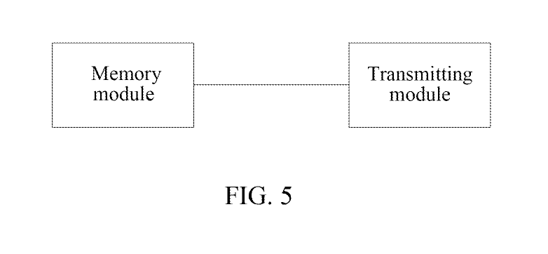

Furthermore, the present document also provides an eNB, as shown in FIG. 5, comprising: a memory module, used to save specific rules; wherein the specific rules are pre-configured in the memory module or pre-indicated by a transmitting module to the user equipment via a high-layer signaling;

the transmitting module, used to transmit data and/or downlink control information to a user equipment within the service range in time division duplexing (TDD) special subframes in accordance with the specific rules saved in the memory module;

wherein, the serving cell in which the user equipment is located currently performs a coordinated multi-point transmission with at least one other cell and has an independent TDD special subframe configuration compared with the other cells.

Preferably, the memory module is further used to save at least one set of non-zero power channel state information reference signal (NZP CSI-RS) configuration pre-configured for the user equipment via the high-layer signaling, wherein each set of NZP CSI-RS configuration corresponds to one set of TDD special subframe configuration signaling; wherein the TDD special subframe configuration signaling comprises a combination of any one or more of the following items:

TDD special subframe configuration index;

TDD uplink and downlink subframe configuration index;

subframe offset information or slot offset information;

the ending position of orthogonal frequency division multiplexing (OFDM) symbols occupied by the data and/or the downlink control information;

the transmitting module is used to transmit data to a user equipment within the service range in the TDD special subframes in accordance with the specific rules, specifically comprising:

the transmitting module is used to send data to the user equipment according to the TDD special subframe configuration corresponding to the first NZP CSI-RS saved in the memory module.

Preferably, the memory module also saves at least one channel state information (CSI) process pre-configured for the user equipment via the high-layer signaling, wherein each CSI process corresponds to one set of TDD special subframe configuration signaling; wherein the TDD special subframe configuration signaling comprises a combination of any one or more of the following items:

TDD special subframe configuration index;

TDD uplink and downlink subframe configuration index;

subframe offset information or slot offset information;

the ending position of orthogonal frequency division multiplexing (OFDM) symbols occupied by the data and/or the downlink control information;

the transmitting module is used to transmit data to a user equipment within the service range in the TDD special subframes in accordance with the specific rules, specifically comprising: the transmitting module is used to send data to the user equipment according to the TDD special subframe configuration signaling corresponding to the first CSI process saved in the memory module

Preferably, the transmitting module is used to transmit data to the user equipment within the service range in the TDD special subframes in accordance with the specific rules saved in the memory module, specifically comprising:

the transmitting module is used for only transmitting data in a cell corresponding to the first NZP CSI-RS; or,

the transmitting module is used for only transmitting data in the serving cell in which the user equipment is located or transmitting data to the user equipment in accordance with the TDD special subframe configuration signaling of the serving cell; or,

the transmitting module is used for only transmitting data in the cell corresponding to the first CSI process.

Preferably, the memory module further saves at least one enhanced physical downlink control channel (EPDCCH) cluster pre-configured for the user equipment via the high-layer signaling, as well as one set of TDD special subframe configuration signaling configured for each EPDCCH cluster; wherein the TDD special subframe configuration signaling comprises a combination of any one or more of the following items:

TDD special subframe configuration index;

TDD uplink and downlink subframe configuration index;

subframe offset information or slot offset information;

the ending position of orthogonal frequency division multiplexing (OFDM) symbols occupied by the data and/or the downlink control information;

the transmitting module is used to: in accordance with the specific rules, transmit downlink control information to the user equipment within the service range in the TDD special subframes, specifically comprising:

the transmitting module is used to transmit the downlink control information to the user equipment within the service range according to special subframe configuration signalings configured for the first EPDCCH cluster; or,

the transmitting module is used to, for each EPDCCH cluster, respectively transmit the downlink control information in the EPDCCH cluster according to the TDD special subframe configuration allocated to the EPDCCH cluster; or,

the transmitting module is used to transmit the downlink control information according to the TDD special subframe configuration signalings configured for the EPDCCH cluster of the serving cell in which the user equipment is located.

Preferably, the transmitting module is used to transmit the downlink control information to the user equipment within the service range in the TDD special subframes in accordance with the specific rules, specifically comprising

the transmitting module is used for only transmitting the downlink control information in the cell corresponding to the first EPDCCH cluster; or,

the transmitting module is used for transmitting the downlink control information in the EPDCCH cluster corresponding to the serving cell in which the user equipment is located.

Preferably, the memory module also saves N special subframe configuration signalings pre-configured for the user equipment through the high-layer signaling;

the transmitting module is further used to: indicate to the user equipment one of the N special subframe configuration signalings corresponding to the subframes which currently transmit the data via the value of at least part of information bits in the transmitted downlink control information (DCI); wherein N is a positive integer;

the transmitting module is used to: transmit data to the user equipment within the service range in the TDD special subframes in accordance with the specific rules, specifically comprising: the transmitting module being used for transmitting a physical downlink shared channel (PDSCH) to the user equipment according to the TDD special subframe configuration signalings indicated by the value of the information bits in the downlink control information.

Preferably, the transmitting module is used to: transmit data and/or downlink control information to the user equipment in the service range in the TDD special subframes in accordance with the specific rules, specifically comprising:

if the transmitting module determines that the user equipment is configured as a specific transmission mode, a DCI format or a specific mode for receiving downlink control information, the transmitting module being used for transmitting data and/or downlink control information to the user equipment in the TDD special subframes in accordance with the specific rules, wherein the specific mode for receiving downlink control information is an EPDCCH transmission or a PDCCH transmission.

Preferably, the transmitting module is used to: if determining that the user equipment is configured as transmission mode 10 and the eNB uses a demodulation reference signal (DMRS) to transmit the PDSCH to the user equipment in the TDD special subframes, only transmit the PDSCH in the serving cell in which the user equipment is located.

Preferably, the transmitting module is used to: if determining that the user equipment is configured as the transmission mode 10 and the eNB uses the DMRS to transmit the PDSCH to the user equipment in the TDD special subframes, and when the DCI format corresponding to the PDSCH is DCI format 1A, only transmit the PDSCH in the serving cell in which the user equipment is located.

Preferably, the transmitting module is used to: if determining that the user equipment is configured as the transmission mode 10 and the present eNB uses the DMRS to transmit the PDSCH to the user equipment in the TDD special subframes, and when the DCI format corresponding to the PDSCH is the DCI format 1A, only transmit the PDSCH in the cell corresponding to the first NZP CSI-RS; or, when the user equipment is configured as the transmission mode 10 and the present eNB uses the DMRS to transmit the PDSCH to the user equipment in the TDD special subframes, and when the DCI format corresponding to the PDSCH is the DCI format 1A, only transmit the PDSCH in the cell corresponding to the first NZP CSI-RS.

Preferably, the transmitting module is used to: if determining that the user equipment is configured as the transmission mode 10 and the present eNB uses the DMRS to transmit the PDSCH to the user equipment in the TDD special subframes, and when the DCI format corresponding to the PDSCH is the DCI format 1A, only transmit the PDSCH in the cell corresponding to the first CSI process.

Preferably, the transmitting module is used to: if determining that the user equipment is configured as the transmission mode 10 and the eNB uses the EPDCCH to transmit downlink control information to the user equipment in the TDD special subframes, only transmit the EPDCCH in the serving cell in which the user equipment is located.

Preferably, the transmitting module is used to: if determining that the user equipment is configured as the transmission mode 10 and the present eNB uses the EPDCCH to transmit downlink control information to the user equipment in the TDD special subframes, only transmit the EPDCCH in the cell corresponding to the first EPDCCH cluster.

Preferably, the eNB specifically comprises:

the transmitting module pre-indicating to the user equipment a NZP CSI-RS configuration or CSI process configuration associated with data transmitted by the present eNB to the user equipment through at least part of information bits in the transmitted DCI, thus instructing the user equipment to use the TDD special subframe configuration corresponding to the NZP CSI-RS configuration or the CSI process configuration to receive data.

Preferably, the at least part of the information bits in the DCI are physical downlink shared channel resource element mapping and Quasi-Co-Location indicator (PQI) bits.

Preferably, when multiple nodes configuring for one user equipment to perform a multi-point transmission have different TDD special subframe configurations, the eNB predefines that only the serving cell transmits data to the user equipment in the corresponding TDD special subframes.

Preferably, when multiple nodes configured for one user equipment to perform a multi-point transmission have different TDD special subframe configurations, and when the difference between the numbers of OFDM symbols in DwPTS areas of two TDD special subframe configurations is greater than N, the eNB predefines that only the serving cell transmits data to the user equipment in the corresponding TDD special subframes, wherein N is a positive integer.

The present document further comprises a user equipment, comprising:

a memory module, used to save specific rules; wherein the specific rules are pre-configured in the memory module or pre-obtained by a receiving module receiving a high-layer signaling sent from an eNB;

a receiving module, used to receive data and/or downlink control information sent by the eNB in time division duplexing (TDD) special subframes according to the specific rules saved in the memory module;

wherein, the serving cell in which the user equipment is located is currently performing a coordinated multipoint transmission with at least one other cell, and has an independent TDD special subframe configuration compared with the other cells.

Preferably, the receiving module is further used to pre-receive at least one set of non-zero power channel state information reference signal (NZP CSI-RS) configuration configured by the eNB for the present user equipment via the high-layer signaling, as well as a respective TDD special subframe configuration signaling corresponding to each set of NZP CSI-RS, and save them into the memory module; wherein the TDD special subframe configuration signaling comprises a combination of any one or more of the following items:

TDD special subframe configuration index;

TDD uplink and downlink subframe configuration index;

subframe offset information or slot offset information;

the ending position of orthogonal frequency division multiplexing (OFDM) symbols occupied by the data and/or the downlink control information;

the receiving module is used to receive data sent by the eNB in the TDD special subframes according to the specific rules, specifically comprising: the receiving module being used to receive the data according to the TDD special subframe configuration corresponding to the first NZP CSI-RS.

Preferably, the receiving module is further used to pre-receive at least one channel state information (CSI) process configured by the eNB for the present user equipment via the high-layer signaling as well as a respective TDD special subframe configuration signaling corresponding to each CSI process, and save them into the memory module; wherein the TDD special subframe configuration signaling comprises a combination of any one or more of the following items:

TDD special subframe configuration index;

TDD uplink and downlink subframe configuration index;

subframe offset information or slot offset information;

the ending position of orthogonal frequency division multiplexing (OFDM) symbols occupied by the data and/or the downlink control information;

the receiving module is used to receive data sent by the eNB in the TDD special subframes according to the specific rules, specifically comprising: the receiving module being used to receive the data according to the TDD special subframe configuration corresponding to the first CSI process.

Preferably, the receiving module is used to receive data sent by the eNB in the TDD special subframe according to the specific rules, specifically comprising:

the receiving module is used for receiving the data in a serving cell in which the present user equipment is located; or,

the receiving module is used for receiving the data according to a TDD special subframe configuration signaling of the serving cell in which the present user equipment is located; or, the receiving module is used for receiving the data in a cell corresponding to the first NZP CSI-RS; or,

the receiving module is used for only receiving the data in a cell corresponding to the first CSI process.

Preferably, the receiving module is further used to pre-receive at least one enhanced physical downlink control channel (EPDCCH) cluster configured by the eNB for the present user equipment via the high-layer signaling as well as one set of TDD special subframe configuration signaling configured for each EPDCCH cluster; wherein the TDD special subframe configuration signaling comprises a combination of any one or more of the following items:

TDD special subframe configuration index;

TDD uplink and downlink subframe configuration index;

subframe offset information or slot offset information;

the ending position of orthogonal frequency division multiplexing (OFDM) symbols occupied by the data and/or the downlink control information;

the receiving module is used to receive downlink control information sent by the eNB in TDD special subframes according to the specific rules, specifically comprising: the receiving module being used to receive the downlink control information according to the TDD special subframe configuration signaling corresponding to the current EPDCCH cluster.

Preferably, the receiving module is used to receive the downlink control information sent by the eNB in the TDD special subframes according to the specific rules, specifically comprising: the receiving module being used for receiving downlink control information in an EPDCCH cluster in accordance with the TDD special subframe configuration signaling corresponding to the serving cell in which the present user equipment is located.

Preferably, the receiving module is further used to pre-receive N special subframe configuration signalings configured by the eNB for the present user equipment via the high-layer signaling as well as the downlink control information (DCI); wherein, the value of at least part of the information bits in the DCI is used for indicating one of the N special subframe configuration signalings corresponding to the subframes in which the eNB currently transmits data; wherein N is a positive integer;

the receiving module is used to receive the downlink data information sent by the eNB in the TDD special subframes in accordance with the specific rules, specifically comprising: the receiving module being used for receiving the data according to the TDD special subframe configuration signaling indicated by the value of the information bits in the received DCI.

Preferably, the receiving module is used to receive data and/or downlink control information sent by the eNB in the TDD special subframes in accordance with the specific rules, specifically comprising: when the present user equipment is configured as a specific transmission mode, a DCI format or a specific mode for receiving downlink control information, the receiving module being used for receiving data and/or downlink control information sent by the eNB in the TDD special subframes according to the specific rules.

Preferably, the receiving module is used to: if the present user equipment is configured as the transmission mode 10 and the present user equipment uses a demodulation reference signal (DMRS) for receiving the PDSCH in the TDD special subframes, use a special subframe configuration of the serving cell in which the present user equipment is located to receive the PDSCH.

Preferably, the receiving module is used to: when the present user equipment is configured as the transmission mode 10 and uses the DMRS to receive the PDSCH in the TDD special subframes, and when the DCI format corresponding to the PDSCH is the DCI format 1A, use the special subframe configuration of the serving cell in which the present user equipment is located to receive the PDSCH.

Preferably, the receiving module is used to: when the user equipment is configured as the transmission mode 10 and the user equipment uses the DMRS to receive the PDSCH in the TDD special subframes, and when the DCI format corresponding to the PDSCH is the DCI format 1A, use the special subframe configuration signaling of the cell corresponding to the first NZP CSI-RS to receive the PDSCH.

Preferably, the receiving module is used to: when the present user equipment is configured as the transmission model 10 and the user equipment uses the DMRS to receive the PDSCH in the TDD special subframes, and when the DCI format corresponding to the PDSCH is the DCI format 1A, use the special subframe configuration signaling of the cell corresponding to the first CSI process to receive the PDSCH.

Preferably, the receiving module is used to: when the user equipment is configured as the transmission mode 10 and the user equipment uses the EPDCCH to receive the downlink control information in the TDD special subframes, use the special subframe configuration of the serving cell where the user equipment is located to receive the EPDCCH.

Preferably, the receiving module is used to: when the user equipment is configured as the transmission mode 10 and the user equipment uses the EPDCCH to receive the downlink control information in the TDD special subframes, use the special subframe configuration corresponding to the first EPDCCH cluster to receive the EPDCCH.

Preferably, the receiving module pre-receives the DCI sent by the eNB to the present user equipment; wherein, at least part of the information in the DCI is used for indicating the NZP CSI-RS configuration or CSI process configuration used by the data transmitted by the eNB to the present user equipment; the receiving module is further used for obtaining the TDD special subframe configuration used for receiving data in the current subframes via the TDD special subframe configuration corresponding to the NZP CSI-RS configuration or the CSI process configuration.

Preferably, the at least part of the information bits in the DCI are physical downlink shared channel resource element mapping and Quasi-Co-Location indicator (PQI) bits.

In the following, a few application examples are used to further describe the present document. It should be noted that, in each of the following application examples, the user equipment can firstly judge whether the corresponding subframes for receiving data are TDD special subframes or not before receiving the data, and if yes, the reception of data is performed according to the corresponding TDD special subframe configuration, otherwise the reception of data is performed in accordance with the ordinary subframe configuration. Specifically, the user equipment can judge whether the corresponding subframes are special subframes or not by receiving the uplink and downlink subframe configuration index.

The first application example

When the eNB determines that the user equipment is configured as the transmission mode 10 and the eNB uses the DMRS to transmit the PDSCH to the user equipment in the TDD special subframes, the eNB only transmits the PDSCH in the serving cell in which the user equipment is located.

When the user equipment is configured as the transmission mode 10 and uses the DMRS to receive the PDSCH in the special subframes, the user equipment uses the TDD special subframe configuration of the serving cell where the user equipment is located to receive the PDSCH.

The second application example:

When the TDD special subframe configurations of multiple coordinated cells are different and the eNB determines that the user equipment is configured as the transmission mode 10, and when the eNB uses the DMRS to transmit the PDSCH to the user equipment in the TDD special subframes, the eNB only transmits the PDSCH in the serving cell in which the user equipment is located.

When the user equipment is configured as the transmission mode 10 and uses the DMRS to receive the PDSCH in the special subframes, the user equipment uses the special subframe configuration of the serving cell where the user equipment is located to receive the PDSCH.

Or,

when the TDD special subframe configurations of multiple coordinated cells are not exactly the same and the eNB determines that the user equipment is configured as the transmission mode 10, and when the eNB uses the DMRS to transmit the PDSCH to the user equipment in the TDD special subframes, the eNB only transmits the PDSCH in the nodes with the same TDD special subframe configuration as that of the serving cell in which the user equipment is located.

when the user equipment is configured as the transmission mode 10 and uses the DMRS to receive the PDSCH in the special subframes, the user equipment uses the special subframe configuration of the serving cell where the user equipment is located to receive the PDSCH.

Or,

when the TDD special subframe configurations of multiple coordinated cells are not exactly the same, the eNB determines that the user equipment is configured as the transmission mode 10, and when the eNB uses the DMRS to transmit the PDSCH to the user equipment in the TDD special subframes, the eNB only transmits the PDSCH in the nodes with the number of OFDM symbols different from that corresponding to the TDD special subframe configuration DwPTS of the serving cell in which the user equipment is located being less than N (N>0).

When the user equipment is configured as the transmission mode 10 and uses the DMRS to receive the PDSCH in the special subframes, the user equipment uses the special subframe configuration of the serving cell where the user equipment is located to receive the PDSCH.

The third application example

When the eNB determines that the user equipment is configured as the transmission mode 10 and the eNB uses the DMRS to transmit the PDSCH to the user equipment in the TDD special subframes, and when the DCI (Downlink Control Information) format corresponding to the PDSCH is the DCI Format 1A, the eNB only transmits the PDSCH in the serving cell in which the user equipment is located.

When the user equipment is configured as the transmission mode 10 and uses the DMRS to receive the PDSCH in the special subframes, and when the DCI format corresponding to the PDSCH is the DCI Format 1A, the user equipment uses the special subframe configuration of the serving cell where the user equipment is located to receive the PDSCH.

The fourth application example

When the eNB determines that the user equipment is configured as the transmission mode 10 and the eNB uses the DMRS to transmit the PDSCH to the user equipment in the TDD special subframes, and when the DCI format corresponding to the PDSCH is the DCI Format 1A, the eNB only transmits the PDSCH in the cell corresponding to the first NZP CSI-RS.

When the user equipment is configured as the transmission mode 10 and uses the DMRS to receive the PDSCH in the TDD special subframes, and when the DCI format corresponding to the PDSCH is the DCI Format 1A, the user equipment uses the TDD special subframe configuration of the cell corresponding to the first NZP CSI-RS to receive the PDSCH.

The fifth application example

When the eNB determines that the user equipment is configured as the transmission mode 10 and the present eNB uses the DMRS to transmit the PDSCH to the user equipment in the TDD special subframes, and when the DCI (Downlink Control Information) format corresponding to the PDSCH is the DCI Format 1A, the eNB only transmits the PDSCH in the cell corresponding to the first CSI process.

When the user equipment is configured as the transmission mode 10 and uses the DMRS to receive the PDSCH in the TDD special subframes, and when the DCI format corresponding to the PDSCH is the DCI Format 1A, the user equipment uses the special subframe configuration of the cell corresponding to the first CSI process to receive the PDSCH.

The sixth application example

When the eNB determines that the user equipment is configured as the transmission mode 10 and the eNB uses the EDPCCH (Enhanced Physical Downlink Control Channel) to transmit the downlink control information to the user equipment in the TDD special subframes, the eNB only transmits the EPDCCH in the serving cell in which the user equipment is located.

When the user equipment is configured as the transmission mode 10 and uses the EPDCCH to receive the downlink control information in the TDD special subframes, the user equipment uses the special subframe configuration of the serving cell where the user equipment is located to receive the EPDCCH.

The seventh application example

When the eNB determines that the user equipment is configured as the transmission mode 10 and the eNB uses the EPDCCH to transmit the downlink control information to the user equipment in the TDD special subframes, the eNB only transmits the EPDCCH in the cell corresponding to the first EPDCCH cluster.

When the user equipment is configured as the transmission mode 10 and uses the EPDCCH to receive the downlink control information in the TDD special subframes, the user equipment uses the TDD special subframe configuration corresponding to the first EPDCCH cluster to receive the EPDCCH.

The eighth application example

The eNB configures N (N≧0) TDD special subframe configurations for the user equipment through the high-layer signaling, and when transmitting the PDSCH in the TDD special subframes, it uses at least part of the bits (such as 1 bit or 2 bits) in the DCI to indicate to the user equipment that the present eNB currently uses which one of the N TDD special subframes to transmit the PDSCH.

The user equipment obtains N (N≧0) TDD special subframe configurations through the high-layer signaling, when receiving the PDSCH, the user equipment uses at least part of bits in the DCI to determine to use which one of the N TDD special subframe configurations currently used by the eNB to receive the PDSCH.

The ninth application example The eNB pre-configures N (N≧0) EPDCCH clusters for the user equipment through the high-layer signaling and configures one set of TDD special subframe configuration for each EPDCCH cluster separately; wherein the special subframe configurations configured for different EPDCCH clusters may be the same or different;

the user equipment obtains N (N≧0) configured EPDCCH clusters through the high-layer signaling, wherein each EPDCCH cluster has an independent special subframe configuration, and when detecting each EPDCCH cluster in the TDD special sub-frames, the user equipment detects the EPDCCH cluster in accordance with the corresponding special subframe configuration.

The tenth application example

The eNB configures four TDD special subframe configurations for the user equipment through the high-layer signaling, and when transmitting the PDSCH in the TDD special subframes, the eNB uses the PQI bits in the DCI to indicate to the user equipment that which one of the N(N≧0) TDD special subframes is currently used by the present eNB to transmit the PDSCH. Wherein, the correspondence between the PQI bits and the four special subframe configurations is as shown in Table 3.

The user equipment obtains four TDD special subframe configurations through the high-layer signaling, and when receiving the PDSCH, the present user equipment uses the PQI bits in the DCI to determine to use the which one of the N (N≧0) TDD special subframe configurations currently used by the eNB to receive the PDSCH.

TABLE 3
The correspondence between PQI bits and four special subframe
configurations

| PQI bits | Special subframe configuration |
|---|---|
| 00 | Special subframe configuration 0 |
| 01 | Special sub-frame configuration 1 |
| 10 | Special subframe configuration 2 |
| 11 | Special subframe configuration 3 |

Or,

the eNB configures three TDD special subframe configurations for the user equipment through the high-layer signaling, and when transmitting the PDSCH in the TDD special subframes, it uses the PQI bits in the DCI to indicate to the user equipment that the eNB currently uses which one of the N (N≧0) TDD special subframes to transmit the PDSCH. Wherein, the correspondence between the PQI bits and the four special subframe configurations is as shown in Table 4.

The user equipment obtains three TDD special subframe configurations through the high-layer signaling, and when receiving the PDSCH, the present user equipment uses the PQI bits in the DCI to determine to use which one of the N (N≧0) TDD special subframe configurations currently used by the eNB to receive the PDSCH.

TABLE 4
The correspondence between PQI bits and four special subframe
configurations

| PQI bits | Special subframe configuration |
|---|---|
| 00 | Special subframe configuration 0 |
| 01 | Special subframe configuration 1 |
| 10 | Special subframe configuration 2 |
| 11 | Special subframe configuration 0 or special |
| | subframe configuration 1 or special subframe |
| | configuration 2 or special subframe |
| | configuration 3 |

The eleventh application example

The eNB pre-configures at least one NZP CSI-RS for the user equipment through the high-layer signaling, and it needs to ensure that the configured at least one NZP CSI-RS are independently configured with the corresponding TDD special subframe configurations.

When the user equipment obtains at least one NZP CSI-RS through the high-layer signaling, the user equipment considers that the configured at least one NZP CSI-RS are independently configured with the corresponding TDD special subframe configurations.

Or,

the eNB pre-configures at least one CSI process for the user equipment through the high-layer signaling, and it needs to ensure that the configured at least one CSI process are independently configured with the corresponding TDD special subframe configurations.

When the user equipment obtains at least one CSI process through the high-layer signaling, the user equipment considers that the configured at least one CSI process are independently configured with the corresponding TDD special subframe configurations.

The twelfth application example

The eNB configures at least one NZP CSI-RS for the user equipment, and separately configures one set of TDD special subframe configuration for each NZP CSI-RS. When the eNB transmits data to the user equipment in the TDD special subframes, the corresponding NZP CSI-RS information in the PQI bits in the DCI is used to indicate to the user equipment the TDD special subframe configuration which should be used when receiving the data in the TDD special subframes.

The user equipment obtains at least one NZP CSI-RS configuration by receiving the high-layer signaling as well as the corresponding TDD special subframe configurations. When receiving the data in one TDD special subframe, the user equipment obtains the corresponding NZP CSI-RS configuration index by detecting the PQI bits in the DCI, thereby obtaining the TDD special subframe configuration of the corresponding NZP CSI-RS configuration, and it receives the data in the TDD special subframe in accordance with the TDD special subframe configuration.

It should be noted that, the EPDCCH (Enhanced Power Control Channel) and PMCH (Physical Multicast Channel) configuration information can also be notified by using the method of the present embodiment.

Those ordinarily skilled in the art can understand that all or some of steps of the abovementioned method may be completed by programs instructing the relevant hardware, and the programs may be stored in a computer-readable storage medium, such as read only memory, magnetic or optical disk. Alternatively, all or some of the steps of the abovementioned embodiments may also be implemented by using one or more integrated circuits. Accordingly, each module/unit in the abovementioned embodiments may be realized in a form of hardware, or in a form of software function modules. The present document is not limited to any specific form of hardware and software combinations.

The above description is only the preferred embodiments of the present invention and is not intended to limit the protection scope of the present document. According to the inventive content of the present document, there may be many other embodiments, and without departing from the spirit and essence of the present document, those skilled in the art can make corresponding changes and modifications in accordance with the present document, and all changes, equivalent replacements and improvements made should be included within the protection scope of the present document.

### INDUSTRIAL APPLICABILITY

In the embodiments of the present invention, it tries to guarantee that all of the TDD special subframes can be used for coordinated multi-point transmission while solving the problem of reception error during performing the coordinated multi-point transmission in the TDD special subframes, thus reducing the scheduling restrictions on the eNB.

What is claimed is:

1. A method for transmitting data and control information, comprising:
an eNB transmitting data and/or downlink control information to a user equipment within a service range in time division duplexing (TDD) special subframes in accordance with specific rules; wherein the specific rules are pre-configured in the eNB or pre-indicated by the eNB to the user equipment via a high-layer signaling;
wherein a serving cell in which the user equipment is located currently performs a coordinated multi-point (CoMP) transmission with one or more other cells and has an independent TDD special subframe configuration compared with the other cells.

2. The method of claim 1, wherein the method further comprises: the eNB pre-configuring at least one set of non-zero power channel state information reference signal (NZP CSI-RS) configuration for the user equipment via the high-layer signaling, wherein each set of NZP CSI-RS configuration corresponds to one set of TDD special subframe configuration signaling; wherein the TDD special subframe configuration signaling comprises a combination of any one or more of following items:
TDD special subframe configuration index;
TDD uplink and downlink subframe configuration index;
subframe offset information or slot offset information;
an ending position of orthogonal frequency division multiplexing (OFDM) symbols occupied by the data and/or the downlink control information;
the eNB transmitting data to the user equipment within the service range in the TDD special subframes in accordance with the specific rules;
or
wherein the method further comprises:
the eNB pre-configuring at least one channel state information (CSI) process for the user equipment through the high-laver signaling, wherein each CSI process corresponds to one set of TDD special subframe configuration signaling; wherein the TDD special subframe configuration signaling comprises a combination of any one or more of following items:
TDD special subframe configuration index;
TDD uplink and downlink subframe configuration index;
subframe offset information or slot offset information;
an ending position of orthogonal frequency division multiplexing (OFDM) symbols occupied by the data and/or the downlink control information;
the eNB transmitting data to the user equipment within the service range in the TDD special subframes in accordance with the specific rules.

3. (canceled)

4. The method of claim 1, wherein the eNB transmitting data to the user equipment within the service range in the TDD special subframes in accordance with the specific rules comprises:
the eNB only transmitting data in a cell corresponding to a first NZP CSI-RS; or,
the eNB only transmitting data in the serving cell in which the user equipment is located or transmitting data to the user equipment according to a TDD special subframe configuration of the serving cell; or,
the eNB only transmitting data in a cell corresponding to a first CSI process;
or
wherein the method further comprises:
the eNB pre-configuring at least one enhanced physical downlink control channel (EPDCCH) cluster for the user equipment through the high-layer signaling, and respectively configuring one set of TDD special subframe configuration signaling for each EPDCCH cluster; wherein the TDD special subframe configuration signaling comprises a combination of any one or more of following items:
TDD special subframe configuration index;
TDD uplink and downlink subframe configuration index;
subframe offset information or slot offset information;
an ending position of orthogonal frequency division multiplexing (OFDM) symbols occupied by the data and/or the downlink control information;
the eNB transmitting downlink control information to the user equipment within the service range in the TDD special subframes in accordance with the specific rules comprises:
the eNB transmitting the downlink control information to the user equipment in the service range in the TDD special subframe in accordance with a special subframe configuration signaling configured for a first EPDCCH cluster; or,
for each EPDCCH cluster, the eNB respectively transmitting the downlink control information in the EPDCCH cluster according to a TDD special subframe configuration signaling configured for the EPDCCH cluster; or,
the eNB transmitting the downlink control information in the TDD special subframes according to a TDD special subframe configuration signaling configured for an EPDCCH cluster of the serving cell in which the user equipment is located;
or
wherein the eNB transmitting the downlink control information to the user equipment in the service range in the TDD special subframes in accordance with the specific rules comprises:
the eNB only transmitting the downlink control information in a cell corresponding to a first EPDCCH cluster; or, the eNB transmitting the downlink control information in an EPDCCH cluster corresponding to the serving cell in which the user equipment is located.

5-6. (canceled)

7. The method of claim 1, wherein the method further comprises:
the eNB pre-configuring N special subframe configuration signalings for the user equipment through the high-layer signaling and indicating to the user equipment one of N special subframe configuration signalings corresponding to subframes which currently transmit data through the value of at least part of information bits in the transmitted downlink control information (DCI); wherein N is a positive integer;
the eNB transmitting data to the user equipment within the service range in the TDD special subframes in accordance with the specific rules comprising: the eNB transmitting a physical downlink shared channel (PDSCH) to the user equipment according to a TDD special subframe configuration signaling indicated by the value of information bits in the downlink control information,
preferably, the at least part of the information bits in the DCI are physical downlink shared channel resource element mapping and Quasi-Co-Location indicator (PQI) bits.

8. The method of claim 1, wherein,
the eNB transmitting data and/or downlink control information to the user equipment in the service range in the TDD special subframes in accordance with the specific rules comprises: if the eNB determines that the user equipment is configured as a specific transmission mode, a DCI format or a specific mode for receiving downlink control information, the eNB transmitting data and/or downlink control information to the user equipment in the TDD special subframes in accordance with the specific rules, wherein the specific mode for receiving downlink control information is an EPDCCH transmission or a PDCCH transmission.

9. The method of claim 8, wherein,
when the eNB determines that the user equipment is configured as transmission mode 10 and the eNB uses a demodulation reference signal (DMRS) to transmit a PDSCH to the user equipment in the TDD special subframes, the eNB only transmits the PDSCH in the serving cell in which the user equipment is located;
or
if the eNB determines that the user equipment is configured as transmission mode 10 and the eNB uses a DMRS to transmit a PDSCH in the TDD special subframes to the user equipment, and when a DCI Format corresponding to the PDSCH is DCI Format 1A, the eNB only transmits the PDSCH in the serving cell in which the user equipment is located;
or
if the eNB determines that the user equipment is configured as transmission mode 10 and the eNB uses a DMRS to transmit a PDSCH to the user equipment in the TDD special subframes, and when a DCI Format corresponding to the PDSCH is DCI Format 1A, the eNB only transmits the PDSCH in the cell corresponding to the first NZP CSI-RS;
or
if the eNB determines that the user equipment is configured as transmission mode 10 and the eNB uses a DMRS to transmit a PDSCH to the user equipment in the specific TDD subframes, and when a DCI Format corresponding to the PDSCH is DCI Format 1A, the eNB only transmits the PDSCH in the cell corresponding to the first CSI process;
or
if the eNB determines that the user equipment is configured as transmission mode 10 and the eNB uses an EPDCCH to transmit downlink control information to the user equipment in the TDD special subframes, the eNB only transmits the EPDCCH in the serving cell in which the user equipment is located;
or
if the eNB determines that the user equipment is configured as transmission mode 10 and the eNB uses an EPDCCH to transmit downlink control information to the user equipment in the TDD special subframes, the eNB only transmits the EPDCCH in the cell corresponding to the first EPDCCH cluster.

10-14. (canceled)

15. The method of claim 2, wherein the eNB pre-indicates to the user equipment a NZP CSI-RS configuration or a CSI process configuration associated with data transmitted by the present eNB to the user equipment through at least part of information bits in the transmitted DCI, and instructs the user equipment to use a TDD special subframe configuration signaling corresponding to the NZP CSI-RS configuration or CSI process configuration to receive data.

16. (canceled)

17. The method of claim 1, wherein, when a plurality of nodes configured for one user equipment to perform a multi-point transmission have different TDD special subframe configurations, the eNB predefines that only the serving cell transmits data to the user equipment in corresponding TDD special subframes;
or
when a plurality of nodes configured for one user equipment to perform a multi-point transmission have different TDD special subframe configurations, and when a difference between the numbers of OFDM symbols in DwPTS areas of two TDD special subframe configurations is greater than N, the eNB predefines that only the serving cell transmits data to the user equipment in corresponding TDD special subframes, wherein N is a positive integer.

18. (canceled)

19. A method for receiving data and control information, comprising:
a user equipment receiving data and/or downlink control information sent by an eNB in time division duplexing (TDD) special subframes according to specific rules; wherein the specific rules are pre-configured in the user equipment or pre-obtained by receiving a high-layer signaling sent by the eNB;
wherein a serving cell in which the user equipment is located is currently performing a coordinated multi-point transmission with at least one other cell and has an independent TDD special subframe configuration compared with the other cells.

20. The method of claim 19, wherein the method further comprises:
the user equipment pre-receiving at least one set of non-zero power channel state information reference signal (NZP CSI-RS) configurations configured by the eNB for the present user equipment via the high-layer signaling, as well as a respective TDD special subframe configuration signaling corresponding to each set of NZP CSI-RS; wherein the TDD special subframe configuration signaling comprises a combination of any one or more of following items:
TDD special subframe configuration index;
TDD uplink and downlink subframe configuration index;
subframe offset information or slot offset information;
an ending position of orthogonal frequency division multiplexing (OFDM) symbols occupied by the data and/or the downlink control information;
the user equipment receiving data sent by the eNB in the TDD special subframes according to the specific rules;
or
wherein the method further comprises:
the user equipment pre-receiving at least one channel state information (CSI) process configured by the eNB for the present user equipment via the high-layer signaling configuration as well as a respective TDD special subframe configuration signaling corresponding to each CSI process; wherein the TDD special subframe configuration signaling comprises a combination of any one or more of following items:
TDD special subframe configuration index;
TDD uplink and downlink subframe configuration index;
subframe offset information or slot offset information;
an ending position of orthogonal frequency division multiplexing (OFDM) symbols occupied by the data and/or the downlink control information;
the user equipment receiving data sent by the eNB in the TDD special subframes according to the specific rules.

21. (canceled)

22. The method of claim 19, wherein,
the user equipment receiving data sent by the eNB in the TDD special subframes according to the specific rules comprises:
the user equipment receiving the data in the serving cell in which the user equipment is located; or,
the user equipment receiving the data according to a TDD special subframe configuration signaling of the serving cell in which the present user equipment is located; or,
the user equipment receiving the data in a cell corresponding to a first NZP CSI-RS; or, the user equipment only receiving the data in a cell corresponding to a first CSI process;
or
wherein the method further comprises:
the user equipment pre-receiving at least one enhanced physical downlink control channel (EPDCCH) cluster configured by the eNB for the present user equipment via the high-layer signaling as well as one set of TDD special subframe configuration signaling configured for each EPDCCH cluster; wherein the TDD special subframe configuration signaling comprises a combination of any one or more of following items:
TDD special subframe configuration index;
TDD uplink and downlink subframe configuration index;
subframe offset information or slot offset information;
an ending position of orthogonal frequency division multiplexing (OFDM) symbols occupied by the data and/or the downlink control information;
the user equipment receiving downlink control information sent by the eNB in the TDD special subframes according to the specific rules comprises: the user equipment receiving the downlink control information according to a TDD special subframe configuration signaling corresponding to a current EPDCCH cluster;
or
wherein the user equipment receiving downlink control information sent by the eNB in the TDD special subframes according to the specific rules comprises: the user equipment receiving downlink control information in an EPDCCH cluster in accordance with a TDD special subframe configuration signaling corresponding to the serving cell in which the present user equipment is located.

23-24. (canceled)

25. The method of claim 19, wherein the method further comprises:
the user equipment pre-receiving N special subframe configuration signalings configured by the eNB for the present user equipment via the high-layer signaling as well as the downlink control information (DCI); wherein, the value of at least part of information bits in the DCI is used for indicating one of N special subframe configuration signalings corresponding to subframes in which the eNB currently transmits data; wherein N is a positive integer;
the user equipment receiving the downlink data information sent by the eNB in the TDD special subframes in accordance with the specific rules comprises: the user equipment receiving the data according to a TDD special subframe configuration signaling indicated by the value of information bits in the received DCI,
preferably, the at least part of the information bits in the DCI are physical downlink shared channel resource element mapping and Quasi-Co-Location indicator (PQI) bits.

26. The method of claim 19, wherein,
the user equipment receiving data and/or downlink control information sent by the eNB in the TDD special subframes in accordance with the specific rules comprises: when the user equipment is configured as a specific transmission mode, a DCI format or a specific mode for receiving downlink control information, the user equipment receiving data and/or downlink control information sent by the eNB in the TDD special subframes according to the specific rules.

27. The method of claim 26, wherein if the user equipment is configured as transmission mode 10 and the user equipment uses a demodulation reference signal (DMRS) for receiving a PDSCH in the TDD special subframes, the user equipment uses a special subframe configuration of the serving cell in which the present user equipment is located to receive the PDSCH;
or
if the user equipment is configured as transmission mode 10 and uses a DMRS to receive a PDSCH in the TDD special subframes, and when a DCI Format corresponding to the PDSCH is DCI Format 1A, the user equipment uses a special subframe configuration of the serving cell in which the present user equipment is located to receive the PDSCH;
or
if the user equipment is configured as transmission mode 10 and the user equipment uses a DMRS to receive a PDSCH in the TDD special subframes, and when a DCI Format corresponding to the PDSCH is DCI Format 1A, the user equipment uses a special subframe configuration signaling of a cell corresponding to a first CSI process to receive the PDSCH;
or
if the user equipment is configured as transmission mode 10 and uses a DMRS to receive a PDSCH in the TDD special subframes, and when a DCI format corresponding to the PDSCH is DCI Format 1A, the user equipment uses a special subframe configuration signaling of a cell corresponding to a first CSI process to receive the PDSCH;
or
if the user equipment is configured as transmission mode 10 and uses an EPDCCH to receive the downlink control information in the TDD special subframes, the user equipment uses a special subframe configuration of the serving cell where the user equipment is located to receive the EPDCCH;
or
if the user equipment is configured as transmission mode 10 and uses an EPDCCH to receive the downlink control information in the TDD special subframes, the user equipment uses a special subframe configuration corresponding to a first EPDCCH cluster to receive the EPDCCH.

28-32. (canceled)

33. The method of claim 20, wherein, the user equipment pre-receives DCI sent by the eNB to the present user equipment; wherein at least part of information in the DCI is used for indicating a NZP CSI-RS configuration or CSI process configuration used by data transmitted by the eNB to the present user equipment; the user equipment obtains a TDD special subframe configuration used for receiving data in current subframes through a TDD special subframe configuration signaling corresponding to the NZP CSI-RS configuration or CSI process configuration.

34. (canceled)

35. The method of claim 19, wherein when a plurality of nodes configured for one user equipment to perform a multi-point transmission have different TDD special subframe configurations, the eNB predefines that only the serving cell transmits data to the user equipment in corresponding TDD special subframes;
or
wherein when a plurality of nodes configured for one user equipment to perform a multi-point transmission have different TDD special subframe configurations, and when a difference between the numbers of OFDM symbols in DwPTS areas of two TDD special subframe configurations is greater than N, the eNB predefines that only the serving cell transmits data to the user equipment in corresponding TDD special subframes, wherein N is a positive integer.

36. (canceled)

37. An eNB, comprising:
a memory module, configured to: save specific rules; wherein the specific rules are pre-configured in the memory module or pre-indicated by a transmitting module to the user equipment via a high-layer signaling;
the transmitting module, configured to: transmit data and/or downlink control information to a user equipment within a service range in time division duplexing (TDD) special subframes in accordance with the specific rules saved in the memory module;
wherein, a serving cell in which the user equipment is located currently performs a coordinated multi-point transmission with at least one other cell and has an independent TDD special subframe configuration compared with the other cells.

38. The eNB of claim 37, wherein,
the memory module is further configured to: save at least one set of non-zero power channel state information reference signal (NZP CSI-RS) configuration pre-configured for the user equipment via the high-layer signaling, wherein each set of NZP CSI-RS configuration corresponds to one set of TDD special subframe configuration signaling; wherein the TDD special subframe configuration signaling comprises a combination of any one or more of following items:
TDD special subframe configuration index;
TDD uplink and downlink subframe configuration index;
subframe offset information or slot offset information;
an ending position of orthogonal frequency division multiplexing (OFDM) symbols occupied by the data and/or the downlink control information;
the transmitting module is configured to: transmit data to the user equipment within the service range in the TDD special subframes in accordance with the specific rules;
or
the memory module is further configured to: save at least one channel state information (CSI) process pre-configured for the user equipment via the high-layer signaling, wherein each CSI process corresponds to one set of TDD special subframe configuration signaling; wherein the TDD special subframe configuration signaling comprises a combination of any one or more of following items:
TDD special subframe configuration index;
TDD uplink and downlink subframe configuration index;
subframe offset information or slot offset information;
an ending position of orthogonal frequency division multiplexing (OFDM) symbols occupied by the data and/or the downlink control information;
the transmitting module is configured to: transmit data to the user equipment within the service range in the TDD special subframes in accordance with the specific rules.

39. (canceled)

40. The eNB of claim 37, wherein, the transmitting module is configured to: transmit data to the user equipment within the service range in the TDD special subframes in accordance with the specific rules saved in the memory module, comprising:
the transmitting module only transmitting data in a cell corresponding to a first NZP CSI-RS; or,
the transmitting module only transmitting data in the serving cell in which the user equipment is located or transmitting data to the user equipment in accordance with a TDD special subframe configuration of the serving cell; or,
the transmitting module only transmitting data in a cell corresponding to a first CSI process;
or
the memory module is further configured to: save at least one enhanced physical downlink control channel (EPDCCH) cluster pre-configured for the user equipment via the high-layer signaling, as well as one set of TDD special subframe configuration signaling configured for each EPDCCH cluster; wherein the TDD special subframe configuration signaling comprises a combination of any one or more of following items:
TDD special subframe configuration index;
TDD uplink and downlink subframe configuration index;
subframe offset information or slot offset information;
an ending position of orthogonal frequency division multiplexing (OFDM) symbols occupied by the data and/or the downlink control information;
the transmitting module is configured to: in accordance with the specific rules, transmit downlink control information to the user equipment within the service range in the TDD special subframes, comprising:
the transmitting module transmitting the downlink control information to the user equipment within the service range according to special subframe configuration signalings configured for a first EPDCCH cluster; or,
for each EPDCCH cluster, the transmitting module respectively transmitting the downlink control information in the EPDCCH cluster according to TDD special subframe configuration signalings configured for the EPDCCH cluster; or,
the transmitting module transmitting the downlink control information according to TDD special subframe configuration signalings configured for an EPDCCH cluster of the serving cell in which the user equipment is located;
or
the transmitting module is configured to: transmit the downlink control information to the user equipment within the service range in the TDD special subframes in accordance with the specific rules, comprising
the transmitting module only transmitting the downlink control information in a cell corresponding to a first EPDCCH cluster; or, the transmitting module transmitting the downlink control information in an EPDCCH cluster corresponding to the serving cell in which the user equipment is located.

41-42. (canceled)

43. The eNB of claim 37, wherein,
the memory module is further configured to: save N special subframe configuration signalings pre-configured for the user equipment through the high-layer signaling;
the transmitting module is further configured to: indicate to the user equipment one of N special subframe configuration signalings corresponding to subframes which currently transmit data via the value of at least part of information bits in the transmitted downlink control information (DCI); wherein N is a positive integer;
the transmitting module is configured to: transmit data to the user equipment within the service range in the TDD special subframes in accordance with the specific rules, comprising:
the transmitting module transmitting a physical downlink shared channel (PDSCH) to the user equipment according to TDD special subframe configuration signalings indicated by the value of information bits in the downlink control information,
preferably, the at least part of the information bits in the DCI are physical downlink shared channel resource element mapping and Quasi-Co-Location indicator (PQI) bits.

44. The eNB of claim 37, wherein, the transmitting module is configured to: transmit data and/or downlink control information to the user equipment in the service range in the TDD special subframes in accordance with the specific rules, comprising: if the transmitting module determines that the user equipment is configured as a specific transmission mode, a DCI format or a specific mode for receiving downlink control information, the transmitting module transmitting data and/or downlink control information to the user equipment in the TDD special subframes in accordance with the specific rules, wherein the specific mode for receiving downlink control information is an EPDCCH transmission or a PDCCH transmission.

45. The eNB of claim 44, wherein,
the transmitting module is configured to: if determining that the user equipment is configured as transmission mode 10 and the eNB uses a demodulation reference signal (DMRS) to transmit a PDSCH to the user equipment in the TDD special subframes, only transmit the PDSCH in the serving cell in which the user equipment is located;
or
the transmitting module is configured to: if determining that the user equipment is configured as transmission mode 10 and the present eNB uses a DMRS to transmit a PDSCH to the user equipment in the TDD special subframes, and when a DCI format corresponding to the PDSCH is DCI Format 1A, only transmit the PDSCH in the serving cell in which the user equipment is locate&
or
the transmitting module is configured to: if determining that the user equipment is configured as transmission mode 10 and the present eNB uses a DMRS to transmit a PDSCH to the user equipment in the TDD special subframes, and when a DCI format corresponding to the PDSCH is DCI Format 1A, only transmit the PDSCH in a cell corresponding to a first NZP CSI-RS; or, when the user equipment is configured as transmission mode 10 and the present eNB uses a DMRS to transmit a PDSCH to the user equipment in the TDD special subframes, and when a DCI format corresponding to the PDSCH is DCI Format 1A, only transmit the PDSCH in a cell corresponding to a first NZP CSI-RS;
or
the transmitting module is configured to: if determining that the user equipment is configured as transmission mode 10 and the present eNB uses a DMRS to transmit a PDSCH to the user equipment in the TDD special subframes, and when a DCI format corresponding to the PDSCH is DCI Format 1A, only transmit the PDSCH in a cell corresponding to a first CSI process;
or
The eNB of claim 44, wherein, the transmitting module is configured to: if determining that the user equipment is configured as transmission mode 10 and the present eNB uses an EPDCCH to transmit downlink control information to the user equipment in the TDD special subframes, only transmit the EPDCCH in the serving cell in which the user equipment is located;
or
the transmitting module is configured to: if determining that the user equipment is configured as transmission mode 10 and the eNB uses an EPDCCH to transmit downlink control information to the user equipment in the TDD special subframes, only transmit the EPDCCH in a cell corresponding to a first EPDCCH cluster.

46-50. (canceled)

51. The eNB of claim 38, wherein,
the transmitting module pre-indicates to the user equipment a NZP CSI-RS configuration or CSI process configuration associated with data transmitted by the present eNB to the user equipment through at least part of information bits in the transmitted DCI, thus instructing the user equipment to use a TDD special subframe configuration corresponding to the NZP CSI-RS configuration or CSI process configuration to receive data.

52. (canceled)

53. The eNB of claim 37, wherein, when a plurality of nodes configuring for one user equipment to perform a multi-point transmission have different TDD special subframe configurations, the eNB predefines that only the serving cell transmits data to the user equipment in corresponding TDD special subframes;
or
when a plurality of nodes configured for one user equipment to perform a multi-point transmission have different TDD special subframe configurations, and when a difference between the numbers of OFDM symbols in DwPTS areas of two TDD special subframe configurations is greater than N, the eNB predefines that only the serving cell transmits data to the user equipment in corresponding TDD special subframes, wherein N is a positive integer.

54. (canceled)

55. A user equipment, comprising:
a memory module, configured to: save specific rules; wherein the specific rules are pre-configured in the memory module or pre-obtained by a receiving module receiving a high-layer signaling sent from an eNB;
a receiving module, configured to: receive data and/or downlink control information sent by the eNB in time division duplexing (TDD) special subframes according to the specific rules saved in the memory module;
wherein, a serving cell in which the user equipment is located is currently performing a coordinated multi-point transmission with at least one other cell, and has an independent TDD special subframe configuration compared with the other cells.

56. The user equipment of claim 55, wherein,
the receiving module is further configured to: pre-receive at least one set of non-zero power channel state information reference signal (NZP CSI-RS) configuration configured by the eNB for the present user equipment via the high-layer signaling, as well as a respective TDD special subframe configuration signaling corresponding to each set of NZP CSI-RS, saving into the memory module;
the receiving module is configured to: receive data sent by the eNB in the TDD special subframes according to the specific rules;
wherein the TDD special subframe configuration signaling comprises a combination of any one or more of following items:
TDD special subframe configuration index;
TDD uplink and downlink subframe configuration index;
subframe offset information or slot offset information;
an ending position of orthogonal frequency division multiplexing (OFDM) symbols occupied by the data and/or the downlink control information;
or
the receiving module is further configured to: pre-receive at least one channel state information (CSI) process configured by the eNB for the present user equipment via the high-layer signaling as well as a respective TDD special subframe configuration signaling corresponding to each CSI process, saving into the memory module; wherein the TDD special subframe configuration signaling comprises a combination of any one or more of following items:
TDD special subframe configuration index;
TDD uplink and downlink subframe configuration index;
subframe offset information or slot offset information;
an ending position of orthogonal frequency division multiplexing (OFDM) symbols occupied by the data and/or the downlink control information;
the receiving module is configured to: receive data sent by the eNB in the TDD special subframes according to the specific rules.

57. (canceled)

58. The user equipment of claim 55, wherein the receiving module is configured to: receive data sent by the eNB in the TDD special subframe according to the specific rules, comprising:
the receiving module receiving the data in the serving cell in which the present user equipment is located; or,
the receiving module receiving the data according to a TDD special subframe configuration signaling of the serving cell in which the present user equipment is located; or,
the receiving module receiving the data in a cell corresponding to a first NZP CSI-RS; or,
the receiving module only receiving the data in a cell corresponding to a first CSI process;
or
the receiving module is further configured to: pre-receive at least one enhanced physical downlink control channel (EPDCCH) cluster configured by the eNB for the present user equipment via the high-layer signaling as well as one set of TDD special subframe configuration signaling configured for each EPDCCH cluster, saving into the memory module; wherein the TDD special subframe configuration signaling comprises a combination of any one or more of following items:
TDD special subframe configuration index;
TDD uplink and downlink subframe configuration index;
subframe offset information or slot offset information;
an ending position of orthogonal frequency division multiplexing (OFDM) symbols occupied by the data and/or the downlink control information;
the receiving module is configured to: receive downlink control information sent by the eNB in TDD special subframes according to the specific rules, comprising: the receiving module receiving the downlink control information according to a TDD special subframe configuration signaling corresponding to a current EPDCCH cluster;
or
the receiving module is configured to: receive the downlink control information sent by the eNB in the TDD special subframes according to the specific rules, comprising: the receiving module being used for receiving downlink control information in an EPDCCH cluster in accordance with a TDD special subframe configuration signaling corresponding to the serving cell in which the present user equipment is located.

59-60. (canceled)

61. The user equipment of claim 55, wherein, the receiving module is further configured to: pre-receive N special subframe configuration signalings configured by the eNB for the present user equipment via the high-layer signaling as well as the downlink control information (DCI); wherein, the value of at least part of information bits in the DCI is used for indicating one of N special subframe configuration signalings corresponding to subframes in which the eNB currently transmits data; wherein N is a positive integer;
the receiving module is further configured to: receive the downlink data information sent by the eNB in the TDD special subframes in accordance with the specific rules, comprising: the receiving module receiving the data according to a TDD special subframe configuration signaling indicated by the value of information bits in the received DCI,
preferably, the at least part of information bits in the DCI are physical downlink shared channel resource element mapping and Quasi-Co-Location indicator (PQI) bits.

62. The user equipment of claim 55, wherein,
the receiving module is further configured to: receive data and/or downlink control information sent by the eNB in the TDD special subframes in accordance with the specific rules, comprising: when the user equipment is configured as a specific transmission mode, a DCI format or a specific mode for receiving downlink control information, the receiving module receiving data and/or downlink control information sent by the eNB in the TDD special subframes according to the specific rules.

63. The user equipment of claim 62, wherein,
the receiving module is configured to: when the user equipment is configured as transmission mode 10 and the present user equipment uses a demodulation reference signal (DMRS) for receiving a PDSCH in the TDD special subframes, use a special subframe configuration of the serving cell in which the present user equipment is located to receive the PDSCH;
or
the receiving module is configured to: if the present user equipment is configured as transmission mode 10 and uses a DMRS to receive a PDSCH in the TDD special subframes, and when a DCI format corresponding to the PDSCH is DCI Format 1A, use a special subframe configuration of the serving cell in which the present user equipment is located to receive the PDSCH;
or
the receiving module is configured to: when the user equipment is configured as transmission mode 10 and the user equipment uses a DMRS to receive a PDSCH in the TDD special subframes, and when a DCI format corresponding to the PDSCH is DCI Format 1A, use a special subframe configuration signaling of a cell corresponding to a first NZP CSI-RS to receive the PDSCH;
or
The user equipment of claim 62, wherein, the receiving module is configured to: when the present user equipment is configured as transmission mode 10 and the user equipment uses a DMRS to receive a PDSCH in the TDD special subframes, and when a DCI format corresponding to the PDSCH is DCI Format 1A, use a special subframe configuration signaling of a cell corresponding to a first CSI process to receive the PDSCH;
or
the receiving module is configured to: when the user equipment is configured as transmission mode 10 and the present user equipment uses an EPDCCH to receive the downlink control information in the TDD special subframes, use a special subframe configuration of the serving cell where the user equipment is located to receive the EPDCCH;
or
the receiving module is configured to: when the present user equipment is configured as transmission mode 10 and the user equipment uses an EPDCCH to receive the downlink control information in the TDD special subframes, use a special subframe configuration corresponding to a first EPDCCH cluster to receive the EPDCCH.

64-68. (canceled)

69. The user equipment of claim 56, wherein,
the receiving module pre-receives DCI sent by the eNB to the present user equipment; wherein, at least part of information in the DCI is used for indicating a NZP CSI-RS configuration or CSI process configuration used by data transmitted by the eNB to the present user equipment; the receiving module is further used for obtaining a TDD special subframe configuration used for receiving data in current subframes via a TDD special subframe configuration corresponding to the NZP CSI-RS configuration or CSI process configuration.

70. (canceled)
